(19) United States
(12) Patent Application Publication
(10) Pub. No.: US 2025/0261246 A1
(43) Pub. Date: Aug. 14, 2025

(54) METHOD AND APPARATUS FOR PERFORMING RANDOM ACCESS IN WIRELESS COMMUNICATION SYSTEM

(71) Applicant: Samsung Electronics Co., Ltd., Suwon-si (KR)

(72) Inventors: Kyungjun CHOI, Suwon-si (KR); Jaeyeon SHIM, Suwon-si (KR); Seongmok LIM, Suwon-si (KR); Youngrok JANG, Suwon-si (KR); Hyoungju JI, Suwon-si (KR)

(21) Appl. No.: 19/037,993

(22) Filed: Jan. 27, 2025

(30) Foreign Application Priority Data
Feb. 14, 2024 (KR) 10-2024-0021003

(51) Int. Cl. H04W 74/0833; H04L 5/14

(52) U.S. Cl. CPC H04W 74/0833; H04L 5/14

(57) ABSTRACT

A user equipment (UE) in a wireless communication system is provided. The UE includes a transceiver, and a controller coupled with the transceiver, and configured to receive, from a base station, first random access channel (RACH) configuration associated with a subband full duplex (SBFD) symbol and second RACH configuration associated with a non-SBFD symbol, and transmit, to the base station, a preamble on a first RACH occasion or a second RACH occasion, wherein the preamble is transmitted on the first RACH occasion in case that the first RACH occasion is valid.

### CROSS-REFERENCE TO RELATED APPLICATION(S)

This application is based on and claims priority under 35 U.S.C. § 119(a) of a Korean patent application number 10-2024-0021003, filed on Feb. 14, 2024, in the Korean Intellectual Property Office, the disclosure of which is incorporated by reference herein in its entirety.

### BACKGROUND

### 1. Field

The disclosure relates to a wireless communication system. More specifically, the disclosure relates to a method and an apparatus for performing a random access in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for enabling a UE which supports subband full duplex (SBFD) communication to perform a random access in a wireless communication system.

Another aspect of the disclosure is to provide a device and a method capable of effectively providing services in a wireless communication system.

Additional aspects will be set forth in part in the description which follows and, in part, will be apparent from the description, or may be learned by practice of the presented embodiments.

In accordance with an aspect of the disclosure, a user equipment (UE) in a wireless communication system is provided. The UE includes a transceiver, and a controller coupled with the transceiver, and configured to receive, from a base station, first random access channel (RACH) configuration associated with a subband full duplex (SBFD) symbol and second RACH configuration associated with a non-SBFD symbol, and transmit, to the base station, a preamble on a first RACH occasion or a second RACH occasion, wherein the preamble is transmitted on the first RACH occasion in case that the first RACH occasion is valid.

In accordance with an aspect of the disclosure, a base station in a wireless communication system is provided. The base station includes a transceiver, and a controller coupled with the transceiver, and configured to transmit, to a user equipment (UE), first random access channel (RACH) configuration associated with a subband full duplex (SBFD) symbol and second RACH configuration associated with a non-SBFD symbol, and receive, from the UE, a preamble on a first RACH occasion or a second RACH occasion, wherein the preamble is received on the first RACH occasion in case that the first RACH occasion is valid.

In accordance with an aspect of the disclosure, a method performed by a user equipment (UE) in a wireless communication system is provided. The method includes receiving, from a base station, first random access channel (RACH) configuration associated with a subband full duplex (SBFD) symbol and second RACH configuration associated with a non-SBFD symbol, and transmitting, to the base station, a preamble on a first RACH occasion or a second RACH occasion, wherein the preamble is transmitted on the first RACH occasion in case that the first RACH occasion is valid.

In accordance with an aspect of the disclosure, a method performed by a base station in a wireless communication system is provided. The method includes transmitting, to a user equipment (UE), first random access channel (RACH) configuration associated with a subband full duplex (SBFD) symbol and second RACH configuration associated with a non-SBFD symbol, and receiving, from the UE, a preamble on a first RACH occasion or a second RACH occasion, wherein the preamble is received on the first RACH occasion in case that the first RACH occasion is valid.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates an example of a control resource set configuration of a downlink (DL) control channel in a wireless communication system according to an embodiment of the disclosure;

FIG. 5 illustrates a structure of a downlink control channel in a wireless communication system according to an embodiment of the disclosure;

FIG. 6 illustrates an example of a method in which a base station and a UE transmit/receive data in consideration of a downlink data channel and a rate matching resource in a wireless communication system according to an embodiment of the disclosure;

FIG. 7 illustrates an example of frequency domain resource allocation with regard to a physical downlink shared channel (PDSCH) in a wireless communication system according to an embodiment of the disclosure;

FIG. 8 illustrates an example of time domain resource allocation with regard to a PDSCH in a wireless communication system according to an embodiment of the disclosure;

FIG. 9 illustrates an example of time domain resource allocation according to a subcarrier spacing with regard to a data channel and a control channel in a wireless communication system according to an embodiment of the disclosure.

FIG. 10 illustrates radio protocol structures of a base station and a UE in single cell, carrier aggregation, and dual connectivity situations according to an embodiment of the disclosure;

FIG. 11 illustrates an example of a random access procedure according to an embodiment of the disclosure;

FIG. 12 illustrates examples of a time division duplex (TDD) configuration and a subband full duplex (SBFD) configuration according to various embodiments of the disclosure;

FIG. 13 illustrates examples of a valid Random Access Channel (RACH) occasion in connection with a TDD configuration and an SBFD configuration according to various embodiments of the disclosure;

FIGS. 14A, 14B, 14C, 14D, 15A, 15B, 16A, 16B, 16C, 16D, and 17 illustrate various methods for f_id of valid RACH occasions according to various embodiments of the disclosure;

FIG. 18 illustrates a structure of a UE in a wireless communication system according to an embodiment of the disclosure; and

FIG. 19 illustrates a structure of a base station in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B (gNB), an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types. Examples of such communication systems may include 5th generation mobile communication technologies (e.g., 5G new radio (NR)) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of third generation partnership project (3GPP), long-term evolution (LTE) or evolved universal terrestrial radio access (E-UTRA), LTE-Advanced (LTE-A), LTE-Pro, high-rate packet data (HRPD) of 3GPP2, ultra-mobile broadband (UMB), Institute of Electrical and Electronics Engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

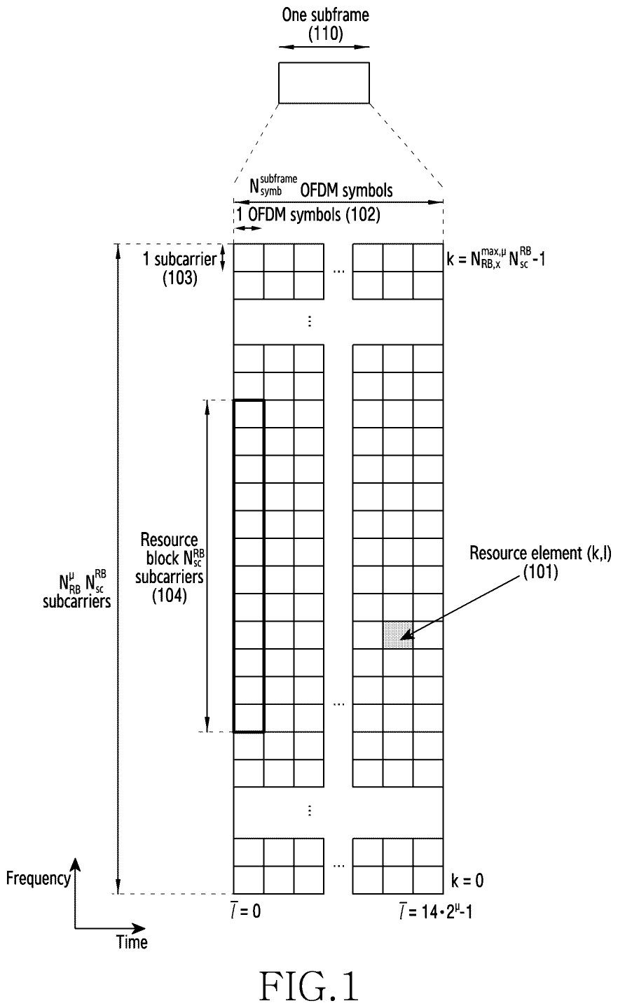

FIG. 1 illustrates a basic structure of a time-frequency domain in a wireless communication system according to an embodiment of the disclosure. More specifically, FIG. 1 illustrates a basic structure of a time-frequency domain, which is a radio resource domain used to transmit data or control channels, in a 5G system.

Referring to FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 among 14 symbols of a subframe 110 on the time axis and one subcarrier 103 on the frequency axis. In the frequency domain, N_{SC}^{RB} (for example, 12) consecutive REs may constitute one resource block (RB) 104.

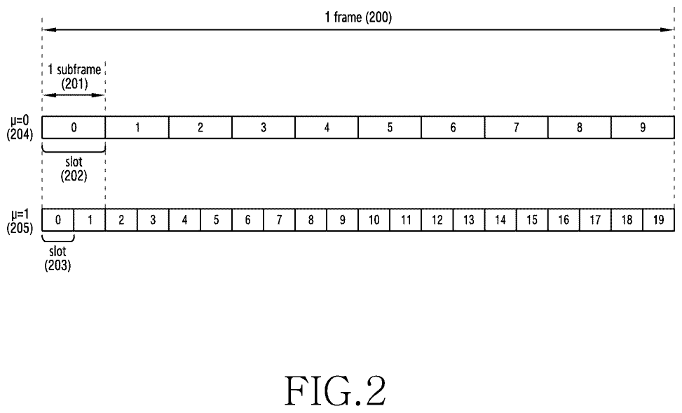

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (for example, the number of symbols per one slot (N_{symb}^{slot})=14). One subframe 201 may include one or multiple slots 202 and 203, and the number of slots 202 and 203 per one subframe 201 may vary depending on configuration values u for the subcarrier spacing 204 or 205.

Referring to FIG. 2, FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number Nₛₗₒₜ^{subframe,μ} of slots per one subframe may change according to a configuration value u for a subcarrier spacing, and the number Nₛₗₒₜ^{frame,μ} of slots per one frame may change accordingly. Nₛₗₒₜ^{subframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

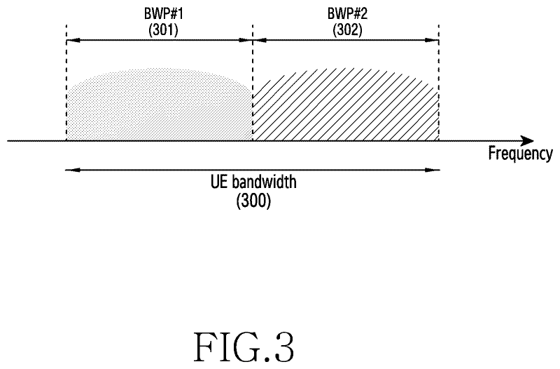

FIG. 3 illustrates an example of a bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |

}

Of course, the configuration information is not limited to the above example, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource set #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The above-described bandwidth part-related configuration supported by the 5G system may be used for various purposes.

According to some embodiments, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to some embodiments, the base station may configure bandwidth parts having different sizes of bandwidths for the UE for the purpose of reducing power consumed by the UE. For example, if the UE supports a substantially large bandwidth (for example, 100 MHz), and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI. The UE may change the bandwidth part to bandwidth part #2 302 indicated by the bandwidth part indicator inside received DCI.

As described above, DCI-based bandwidth part changing may be indicated by DCI for scheduling a PDSCH or a physical uplink shared channel (PUSCH). Therefore, upon receiving a bandwidth part change request, the UE needs to be able to receive or transmit the PDSCH or PUSCH scheduled by the corresponding DCI, in the changed bandwidth part with no problem. To this end, requirements for the delay time (T_{BWP}) required during a bandwidth part change are specified in standards, and may be defined given in Table 3 below, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}Depends on UE capability.
^{Note 2}If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. In addition, the UE may transmit/receive a data channel scheduled by the corresponding DCI in the changed new bandwidth part. If the base station wants to schedule a data channel by using the new bandwidth part, the base station may determine time domain resource allocation regarding the data channel in consideration of the UE's bandwidth part change delay time (T_{BWP}). For example, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Next, synchronization signal (SS)/PBCH blocks in 5G will be described.

An SS/PBCH block may refer to a physical layer channel block including
a primary synchronization signal (PSS), a secondary synchronization signal (SSS), and a PBCH. Details thereof are as follows.
PSS: a signal which becomes a reference of downlink time/frequency synchronization, and provides partial information of a cell ID.
SSS: becomes a reference of downlink time/frequency synchronization, and provides remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to, for example, a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in view of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. The RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by a random access RNTI (RA-RNTI). DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

TABLE 4

| | |
|---|---|
| - | Identifier for DCI formats - [1] bit |
| - | Frequency domain resource assignment - |

[┌log₂ ( N_{RB}^{UL,BWP}(N_{RB}^{UL,BWP} + 1)/2)┐ ] bits

| | |
|---|---|
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | Hybrid automatic repeat request (HARQ) process number - 4 bits |
| - | TPC command for scheduled PUSCH- [2] bits |
| - | UL/supplementary uplink (SUL) indicator - 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
        • For resource allocation type 0, ┌N_{RB}^{UL,BWP}/P┐ bits
        • For resource allocation type 1, ┌log2( N_{RB}^{UL,BWP}
          (N_{RB}^{UL,BWP} + 1)/2┐ bits
  - Time domain resource assignment - 1, 2, 3, or 4 bits
  - Virtual resource block (VRB)-to-physical resource block (PRB)
mapping - 0 or 1 bit, only for resource allocation type 1.
        • 0 bit if only resource allocation type 0 is configured;
        • 1 bit otherwise.
  - Frequency hopping flag - 0 or 1 bit, only for resource allocation type
1.
        • 0 bit if only resource allocation type 0 is configured;
        • 1 bit otherwise.
  - Modulation and coding scheme - 5 bits
  - New data indicator - 1 bit
  - Redundancy version - 2 bits
  - HARQ process number - 4 bits
  - 1st downlink assignment index - 1 or 2 bits
        • 1 bit for semi-static HARQ-acknowledgment (ACK)
          codebook;
        • 2 bits for dynamic HARQ-ACK codebook with single
          HARQ-ACK codebook.
  - 2nd downlink assignment index - 0 or 2 bits
        • 2 bits for dynamic HARQ-ACK codebook with two HARQ-
          ACK sub-codebooks;
        • 0 bit otherwise.
  - TPC command for scheduled PUSCH - 2 bits
  - Sounding reference signal (SRS) resource indicator -
$⌈ {log}_{2} ( {\sum }_{k = 1}^{{L}_{max} \sum } ( \begin{matrix}{N}_{SRS} \\ k\end{matrix} ) ( ) ) ⌉ or ⌈ {log}_{2} ( {N}_{SRS} ) ⌉ bits$
        $⌈ {log}_{2} ( {\sum }_{k = 1}^{{L}_{max} \sum } ( \begin{matrix}{N}_{SRS} \\ k\end{matrix} ) ( ) ) ⌉ bits for non - codebook based$
          PUSCH transmission;
        • ┌log₂(N_{SRS})┐ bits for codebook based PUSCH transmission.
  - Precoding information and number of layers-up to 6 bits
  - Antenna ports - up to 5 bits
  - SRS request - 2 bits
  - Channel state information (CSI) request - 0, 1, 2, 3, 4, 5, or 6 bits
  - Code block group (CBG) transmission information - 0, 2, 4, 6, or 8
bits
  - Phase tracking reference signal (PTRS)-demodulation reference
signal (DMRS) association - 0 or 2 bits.
  - beta_offset indicator - 0 or 2 bits
  - Demodulation reference signal (DMRS) sequence initialization - 0 or
1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

TABLE 6

| | |
|---|---|
| - | Identifier for DCI formats - [1] bit |
| - | Frequency domain resource assignment -[┌log₂ ( N_{RB}^{UL,BWP}(N_{RB}^{UL,BWP} + |

1)/2)┐ ] bits

| | |
|---|---|
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator- 3 bits |
| - | PDSCH-to-HARQ feedback timing indicator- [3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |

| | |
|---|---|
| • | For resource allocation type 0, ┌N_{RB}^{DL,BWP} /P┐ bits |
| • | For resource allocation type 1, ┌log₂ ( N_{RB}^{DL,BWP}(N_{RB}^{DL,BWP} + |
| | 1)/2)┐ bits |

| | |
|---|---|
| - | Time domain resource assignment −1, 2, 3, or 4 bits |
| - | VRB-to-PRB mapping - 0 or 1 bit, only for resource allocation type |

1.

| | |
|---|---|
| • | 0 bit if only resource allocation type 0 is configured; |
| • | 1 bit otherwise. |

| | |
|---|---|
| - | PRB bundling size indicator - 0 or 1 bit |
| - | Rate matching indicator - 0, 1, or 2 bits |
| - | Zero power channel state information reference signal (ZP CSI-RS) |

trigger - 0, 1, or 2 bits

| For transport block (TB) 1: | |
|---|---|
| - | Modulation and coding scheme - 5 bits |
| - | New data indicator - 1 bit |
| - | Redundancy version - 2 bits |
| For transport block 2: | |
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication- 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, and Search Space]

Hereinafter, a downlink control channel in a 5G communication system will be described in more detail with reference to the accompanying drawings.

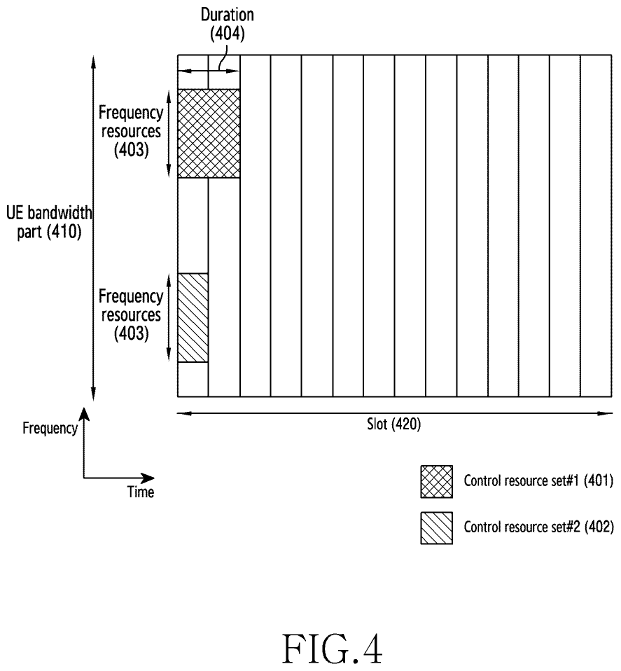

FIG. 4 illustrates an example of a control resource set configuration of a downlink control channel in a wireless communication system according to an embodiment of the disclosure. FIG. 4 illustrates an example in which a UE bandwidth part 410 is configured along the frequency axis, and two CORESETs (CORESET #1 401 and CORESET #2 401) are configured within one slot 420 along the time axis. The control resource sets 401 and 402 may be configured in a specific frequency resources 403 within the entire UE bandwidth part 410 along the frequency axis. The control resource sets may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

The base station may configure a control resource set in 5G described above for the UE through upper layer signaling (for example, system information, master information block (MIB), radio resource control (RRC) signaling). The description that a control resource set is configured for a UE may mean that information such as a control resource set identity, the control resource set's frequency location, and the control resource set's symbol duration is provided. For example, the information for configuring a control resource set may include the following pieces of information in Table 8 below.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |
| frequencyDomainResources | BIT STRING (SIZE (45)), |
| duration | INTEGER |

(1..maxCoReSetDuration),

| | |
|---|---|
| cce-REG-MappingType | CHOICE { |
| interleaved | SEQUENCE { |
| reg-BundleSize | ENUMERATED {n2, |

n3, n6},

| | |
|---|---|
| precoderGranularity | ENUMERATED |

{sameAsREG-bundle, allContiguousRBs},

| | |
|---|---|
| interleaverSize | ENUMERATED {n2, |

```
      n3, n6}
        shiftIndex
        INTEGER(0..maxNrofPhysicalResourceBlocks-1)
          OPTIONAL
    },
```

| | |
|---|---|
| nonInterleaved | NULL |

},

| | |
|---|---|
| tci-StatesPDCCH | SEQUENCE(SIZE |

```
      (1..maxNrofTCI-StatesPDCCH)) OF TCI-StateId
        OPTIONAL,
```

| | |
|---|---|
| tci-PresentInDCI | ENUMERATED {enabled} |
| | OPTIONAL, -- Need S |

}

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

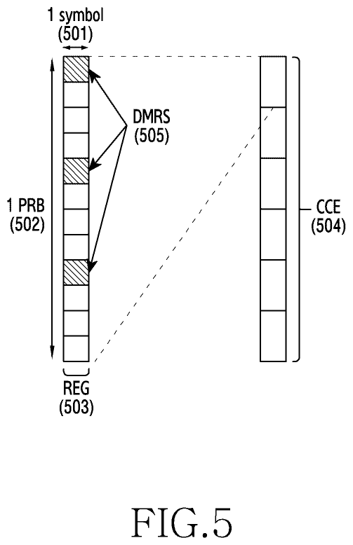

FIG. 5 illustrates a structure of a downlink control channel in a wireless communication system according to an embodiment of the disclosure. More specifically, FIG. 5 illustrates an example of a basic unit of time and frequency resources constituting a downlink control channel available in a 5G system.

According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 505 may be transmitted inside one REG 503. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs.

The UE needs to detect a signal while being no information regarding the downlink control channel, and thus a search space indicating a set of CCEs may be defined for blind decoding. The search space may be a set of downlink control channel candidates including CCEs that the UE must attempt to decode in a given aggregation level. Since there are various aggregation levels making one bundle of 1, 2, 4, 8, or 16 CCEs, the UE may have a plurality of search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically based on a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, parameters of the search space for the PDCCH may include the following pieces of information given in Table 9 below.

TABLE 9

| | |
|---|---|
| SearchSpace ::= | SEQUENCE { |

```
  -- Identity of the search space. SearchSpaceId = 0 identifies the
    SearchSpace configured via PBCH (MIB) or
    ServingCellConfigCommon.
```

| | |
|---|---|
| searchSpaceId | SearchSpaceId, |
| controlResourceSetId | ControlResourceSetId, |
| monitoringSlotPeriod- | CHOICE { |
| icityAndOffset | |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

OPTIONAL,

duration INTEGER (2..2559)

| | |
|---|---|
| monitoringSymbolsWithinSlot | BIT STRING (SIZE |
| (14)) | OPTIONAL, |
| nrofCandidates | SEQUENCE { |
| aggregationLevel1 | ENUMERATED {n0, n1, n2, |

n3, n4, n5, n6, n8},

| | |
|---|---|
| aggregationLevel2 | ENUMERATED {n0, n1, n2, |

n3, n4, n5, n6, n8},

| | |
|---|---|
| aggregationLevel4 | ENUMERATED {n0, n1, n2, |

n3, n4, n5, n6, n8},

| | |
|---|---|
| aggregationLevel8 | ENUMERATED {n0, n1, n2, |

n3, n4, n5, n6, n8},

| | |
|---|---|
| aggregationLevel16 | ENUMERATED {n0, n1, n2, |

```
    n3, n4, n5, n6, n8}
  },
```

| | |
|---|---|
| searchSpaceType | CHOICE { |

```
      -- Configures this search space as common search space (CSS) and
    DCI formats to monitor.
```

| | |
|---|---|
| common | SEQUENCE { |

}

| | |
|---|---|
| ue-Specific | SEQUENCE { |

```
        -- Indicates whether the UE
        monitors in this USS for DCI formats
    0-0 and 1-0 or for formats 0-1 and 1-1.
```

| | |
|---|---|
| formats | ENUMERATED |

```
    {formats0-0-And-1-0, formats0-1-And-1-1},
      ...
}
```

According to configuration information, the base station may configure one or multiple search space sets for the UE. According to some embodiments, the base station may configure search space set 1 and search space set 2 for the UE. The base station may configure search space set 1 for the UE to monitor DCI format A scrambled by an X-RNTI in a common search space, and may configure search space set 2 for the UE to monitor DCI format B scrambled by a Y-RNTI in a UE-specific search space.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs below may be monitored in the common search space, but they are merely examples and the disclosure is not limited to the following examples.

DCI format 0_0/1_0 with CRC scrambled by C-RNTI, CS-RNTI, SP-CSI-RNTI, RA-RNTI, TC-RNTI, P-RNTI, SI-RNTI

DCI format 2_0 with CRC scrambled by SFI-RNTI

DCI format 2_1 with CRC scrambled by INT-RNTI

DCI format 2_2 with CRC scrambled by TPC-PUSCH-RNTI, TPC-PUCCH-RNTI

DCI format 2_3 with CRC scrambled by TPC-SRS-RNTI

Combinations of DCI formats and RNTIs below may be monitored in the UE-specific search space, but they are merely examples and the disclosure is not limited to the following examples.

DCI format 0_0/1_0 with CRC scrambled by C-RNTI, CS-RNTI, TC-RNTI

DCI format 1_0/1_1 with CRC scrambled by C-RNTI, CS-RNTI, TC-RNTI

Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI (SI-RNTI): used to schedule a PDSCH in which system information is transmitted

Interruption RNTI (INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI): used to indicate a power control command regarding a PUCCH

Transmit power control for SRS RNTI (TPC-SRS-RNTI): used to indicate a power control command regarding an SRS

The DCI formats enumerated above may follow the definitions given in Table 10 below, for example.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,nc}_{_{CI}}=0, . . . , M_{s,max}^{(L)}−1: PDCCH candidate index at aggregation level L

$$- i = 0 , … , L - 1$$

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

$$The {Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 9), and the group of search space sets monitored by the UE at each timepoint may differ accordingly. For example, if search space set #1 is configured by X-slot cycle, if search space set #2 is configured at by Y-slot cycle, and if X and Y are different, the UE may monitor search space set #1 and search space set #2 both in a specific slot, and may monitor one of search space set #1 and search space set #2 in another specific slot.

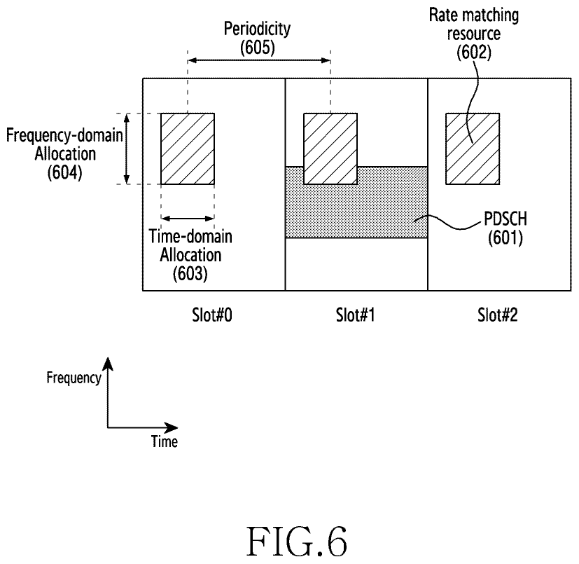

FIG. 6 illustrates an example of a method in which a base station and a UE transmit/receive data in consideration of a downlink data channel and a rate matching resource in a wireless communication system according to an embodiment of the disclosure.

Referring to FIG. 6, FIG. 6 illustrates a downlink data channel (PDSCH) 601 and a rate matching resource 602. The base station may configure one or multiple rate matching resources 602 for the UE through upper layer signaling (for example, RRC signaling). Rate matching resource 602 configuration information may include time-domain resource allocation information 603, frequency-domain resource allocation information 604, and periodicity information 605. A bitmap corresponding to the frequency-domain resource allocation information 604 will hereinafter be referred to as “first bitmap”, a bitmap corresponding to the time-domain resource allocation information 603 will be referred to as “second bitmap”, and a bitmap corresponding to the periodicity information 605 will be referred to as “third bitmap”. If all or some of time and frequency resources of the scheduled PDSCH 601 overlap a configured rate matching resource 602, the base station may rate-match and transmit the PDSCH 601 in a rate matching resource 602 part, and the UE may perform reception and decoding after assuming that the PDSCH 602 has been rate-matched in a rate matching resource 602 part.

The base station may dynamically notify the UE, through DCI, of whether the PDSCH will be rate-matched in the configured rate matching resource part through an additional configuration (for example, corresponding to “rate matching indicator” inside DCI format described above). To be specific, the base station may select some of the configured rate matching resources and group the selected rate matching resources into rate matching resource groups. The base station may indicate, to the UE, whether data channels are rate-matched to the respective rate matching groups, by using a bitmap scheme through DCI. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

The UE may have a maximum of four RateMatchPatterns configured per each bandwidth part through upper layer signaling, and one RateMatchPattern may include the following contents. Obviously, the example given below is not limiting.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may be across one or more slots (for example, may span one or two slots). A time domain pattern (periodicity AndPattern) may be additionally configured wherein time and frequency domains including respective RB-level and symbol-level bitmap pairs are repeated.
may include a resource area corresponding to a time domain pattern configured by time and frequency domain resource areas configured by a CORESET inside a bandwidth part and a search space configuration in which corresponding resource areas are repeated.

### RE Level

The UE may have the following contents configured through upper layer signaling. Obviously, the example given below is not limiting.
configuration information (Ite-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### [PDSCH: Regarding Frequency Resource Allocation]

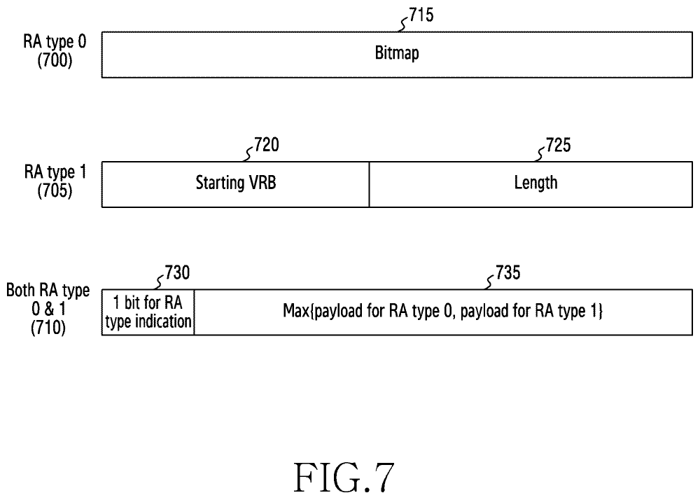

FIG. 7 illustrates an example of frequency domain resource allocation with regard to a physical downlink shared channel (PDSCH) in a wireless communication system according to an embodiment of the disclosure.

FIG. 7 illustrates three frequency domain resource allocation methods of type-0 700, type-1 705, and dynamic switch which can be configured through an upper layer in an NR wireless communication system.

Referring to FIG. 7, in the case in which a UE is configured to use only resource allocation type-0 700 through upper layer signaling, partial downlink control information (DCI) for allocating a PDSCH to the UE includes a bitmap 715 including NRBG bits. Here, NRBG may refer to the number of resource block groups (RBGs) determined according to the BWP size allocated by a BWP indicator and upper layer parameter rbg-Size, as in Table 11 below, and data is transmitted in RBGs indicated as “1” by the bitmap.

TABLE 11

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

If the UE is configured to use only resource allocation type-1 (705) through higher layer signaling, some DCI for allocating PDSCHs to the UE may include frequency domain resource allocation information including [log₂(N_{RB}^{DL,BWP}(N_{RB}^{DL,BWP}+1)/2] bits. The base station may thereby configure a starting virtual resource block (VRB) 720 and the length 725 of a frequency domain resource allocated continuously therefrom.

In the case in which the UE is configured to use both resource allocation type-0 and resource allocation type-1 (710) through upper layer signaling, partial DCI for allocating a PDSCH to the corresponding UE includes frequency domain resource allocation information including as many bits as the larger value 735 between the payload 715 for configuring resource allocation type-0 and the payload 720 and 725 for configuring resource allocation type-1. The conditions for this will be described again later. One bit 730 may be added to the foremost part (MSB) of the frequency domain resource allocation information inside the DCI, and if the bit has the value of “0”, use of resource type-0 may be indicated, and if the bit has the value of “1”, use of resource type-1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL−Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 12 or Table 13 below may be transmitted from the base station to the UE.

TABLE 12
PDSCH-TimeDomainResourceAllocationList information element

```
  -- ASN1START
  -- TAG-PDSCH-TIMEDOMAINRESOURCEALLOCATIONLIST-START
```

| | |
|---|---|
| PDSCH-TimeDomainResourceAllocationList ::= | SEQUENCE |

(SIZE(1..maxNrofDL-Allocations)) OF
PDSCH-TimeDomainResourceAllocation

| | |
|---|---|
| PDSCH-TimeDomainResourceAllocation ::= | SEQUENCE { |
| k0 | INTEGER(0..32) |

OPTIONAL, -- Need S

| | |
|---|---|
| mappingType | ENUMERATED {typeA, typeB}, |
| startSymbolAndLength | INTEGER (0..127) |

}

TABLE 13
PUSCH-TimeDomainResourceAllocationList information element

```
  -- ASN1START
    -- TAG-PUSCH-TIMEDOMAINRESOURCEALLOCATIONLIST-START
```

| | |
|---|---|
| PUSCH-TimeDomainResourceAllocationList ::= | SEQUENCE |

(SIZE(1..maxNrofUL-Allocations)) OF
PUSCH-TimeDomainResourceAllocation

| PUSCH-TimeDomainResourceAllocation ::= | SEQUENCE { | |
|---|---|---|
| k2 | INTEGER(0..32) | OPTIONAL, |

-- Need S

| | |
|---|---|
| mappingType | ENUMERATED {typeA, typeB}, |
| startSymbolAndLength | INTEGER (0..127) |

}

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

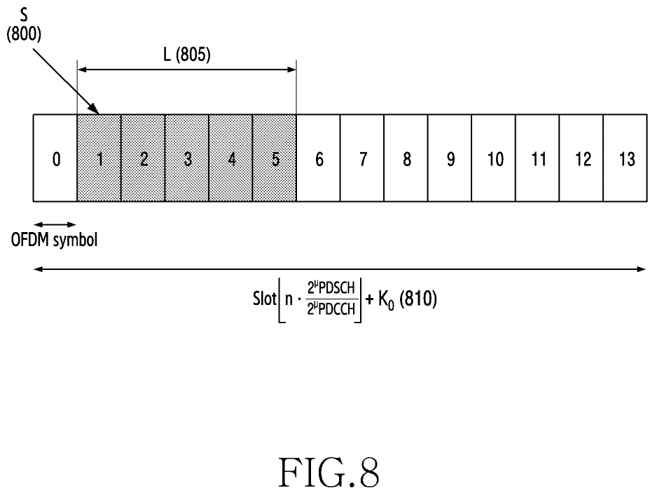

FIG. 8 illustrates an example of time domain resource allocation with regard to a PDSCH in a wireless communication system according to an embodiment of the disclosure.

Referring to FIG. 8, the UE may indicate the time domain location of a PDSCH resource according to the subcarrier spacing (SCS) (μ_{PDSCH}, μ_{PDCCH}) of a data channel and a control channel configured by using an upper layer, the scheduling offset (K0) value, and the OFDM symbol start location 800 and length 805 within one slot 810 dynamically indicated through DCI.

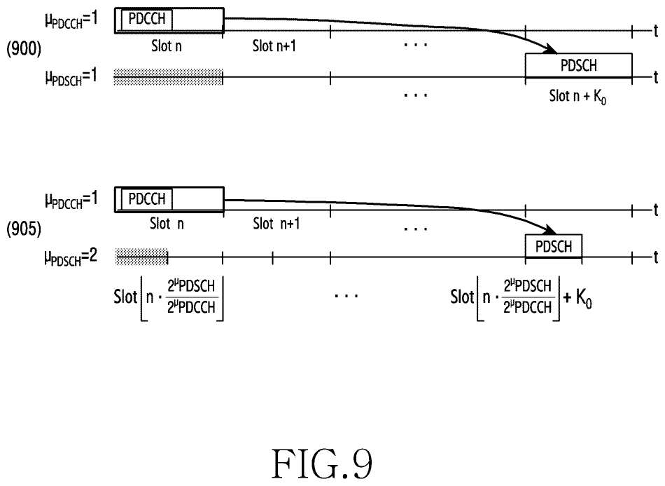

FIG. 9 illustrates an example of time domain resource allocation according to a subcarrier spacing with regard to a data channel and a control channel in a wireless communication system according to an embodiment of the disclosure.

Referring to FIG. 9, if the data channel and the control channel have the same subcarrier spacing (900, μ_{PDSCH}=μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings (905, μ_{PDSCH}≠μ_{PDCCH}), the slot number for data and that for control are different, and the base station and the UE may accordingly generate a scheduling offset in conformity with a predetermined slot offset K0 with reference to the subcarrier spacing of the PDCCH.

### [PUSCH: Regarding Transmission Scheme]

Hereinafter, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 16 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 14 through upper signaling. If PUSCH transmission is operated by a configured grant, parameters applied to the PUSCH transmission are applied through configuredGrantConfig (upper signaling) in Table 16 except for dataScramblingIdentityPUSCH, txConfig, codebookSubset, maxRank, and scaling of UCI-OnPUSCH, which are provided by pusch-Config (upper signaling) in Table 17. If provided with transformPrecoder inside configuredGrantConfig (upper signaling) in Table 14, the UE applies tp-pi2BPSK inside pusch-Config in Table 15 to PUSCH transmission operated by a configured grant.

TABLE 14

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...
  }
OPTIONAL, -- Need R
  ...
}
```

Hereinafter, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 15, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The PUSCH transmission is based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 15, the UE may not expect scheduling through DCI format 0_1.

TABLE 15

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, |
| nonCodebook} | OPTIONAL, -- Need S |
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |

pusch-PowerControl
OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF |

INTEGER (1..maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, |
| qam64LowSE} | OPTIONAL, -- Need S |
| mcs-TableTransformPrecoder | ENUMERATED {qam256, |
| qam64LowSE} | OPTIONAL, -- Need S |
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent, nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Hereinafter, non-codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be indicated through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. The TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE does not expect that the value of codebook Subset (upper signaling) will be configured as “fullyAndPartialAndNonCoherent”. If the UE reported “nonCoherent” as UE capability, UE may not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”. One SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling. The base station may select one from the SRS resources transmitted by the UE and indicate the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Hereinafter, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected non-zero power CSI-RS (NZP CSI-RS) resource may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI may not indicate cross carrier or cross BWP scheduling. If the value of SRS request indicates the existence of a NZP CSI-RS, the NZP CSI-RS may be positioned in the slot used to transmit the PDCCH including the SRS request field. In this case, TCI states configured for the scheduled subcarrier may not be configured as -TypeD.

If there is a periodic or semi-persistent SRS resource set configured, the connected NZP CSI-RS may be indicated through associated CSI-RS inside SRS-ResourceSet (upper signaling). With regard to non-codebook-based transmission, the UE may not expect that spatialRelationInfo which is upper signaling regarding the SRS resource and associated CSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE. The UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”. The base station may select one or multiple SRS resources from the received one or multiple SRS resources. In connection with the non-codebook-based PUSCH transmission, the SRI may indicate an index that may express one SRS resource or a combination of multiple SRS resources. The SRI may be included in DCI. The number of SRS resources indicated by the SRI transmitted by the base station may be the number of transmission layers of the PUSCH. The UE may transmit the PUSCH by applying the precoder applied to SRS resource transmission to each layer.

### [Regarding CA/DC]

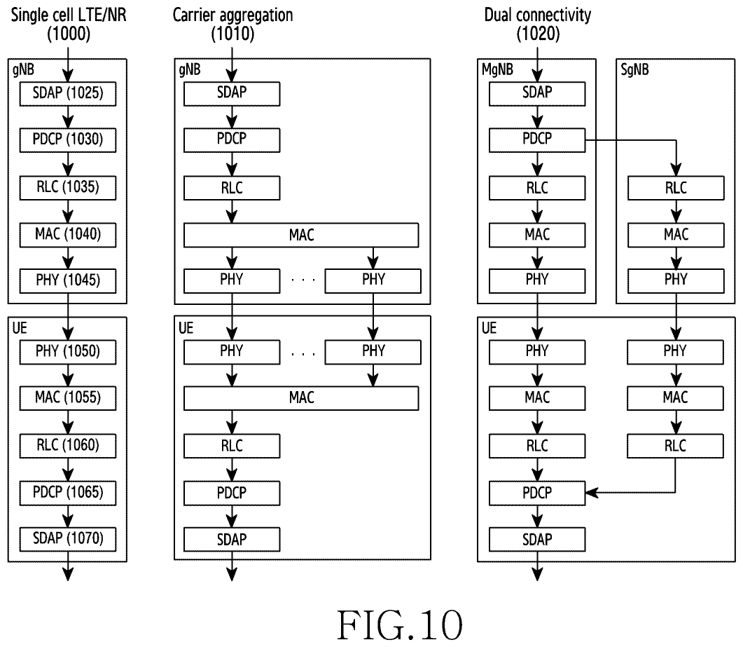

FIG. 10 illustrates radio protocol structures of a base station and a UE in single cell 1000, carrier aggregation 1010, and dual connectivity 1020 situations according to an embodiment of the disclosure.

Referring to FIG. 10, the radio protocol of a next-generation mobile communication system includes an NR service data adaptation protocol (SDAP) 1025 or 1070, an NR packet data convergence protocol (PDCP) 1030 or 1065, an NR radio link control (RLC) 1035 or 1060, and an NR medium access controls (MAC) 1040 or 1055, on each of UE and NR base station sides.

The main functions of the NR SDAP 1025 or 1070 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. →If an SDAP header is configured, the non-access stratum (NAS) quality of service (QOS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1030 or 1065 may include some of the following functions: below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device may refer to a function of reordering PDCP PDU received from a lower layer in an order based on PDCP sequence numbers (SNs). The reordering may include a function of transferring data to an upper layer in the reordered sequence. The reordering of the NR PDCP device may include a function of instantly transferring data without considering the order, and may include a function of recording PDCP PDUs lost as a result of reordering. The reordering may include a function of reporting the state of the lost PDCP PDUs to the transmitting side, and may include a function of requesting retransmission of the lost PDCP PDUs.

The main functions of the NR RLC 1035 or 1060 may include some of the following functions: below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device may refer to a function of successively delivering RLC SDUs received from the lower layer to the upper layer. The in-sequence delivery of the NR RLC device may include a function of, if one original RLC SDU is segmented into multiple RLC SDUs and the segmented RLC SDUs are received, reassembling the RLC SDUs and delivering the reassembled RLC SDUs. The in-sequence delivery of the NR RLC device may include a function of reordering the received RLC PDUs with reference to the RLC sequence number (SN) or PDCP sequence number (SN) and a function of recording RLC PDUs lost as a result of reordering. The in-sequence delivery of the NR RLC device may include a function of reporting the state of the lost RLC PDUs to the transmitting side, and may include a function of requesting retransmission of the lost RLC PDUs. The in-sequence delivery function of the NR RLC device may include a function of, if there is a lost RLC SDU, successively delivering only RLC SDUs before the lost RLC SDU to the upper layer. The in-sequence delivery function of the NR RLC device may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device may process RLC PDUs in the received order (regardless of the sequence number order, in the order of arrival) and deliver same to the PDCP device regardless of the order (out-of-sequence delivery). The in-sequence delivery of the NR RLC device may, in the case of segments, receive segments which are stored in a buffer or which are to be received later, reconfigure same into one complete RLC PDU, and then process and deliver same to the PDCP device. The NR RLC layer may include no concatenation function, which may be performed in the NR MAC layer or replaced with a multiplexing function of the NR MAC layer.

Among the above-described functions, the in-sequence delivery of the NR RLC device may refer to a function of delivering RLC SDUs, received from the lower layer, to the upper layer in sequence. The out-of-sequence delivery of the NR RLC device may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 1040 or 1055 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1045 or 1050 may perform operations of channel-coding and modulating upper layer data, thereby obtaining OFDM symbols, and delivering the same through a radio channel. The NR PHY layer may perform operations of demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 400. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 410. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 410.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may improve the PDCCH reception reliability of a UE by providing a PDCCH repetitive transmission method through multiple transmission points (TRPs). Specific methods thereof will be described hereinafter through the embodiments below.

Hereinafter, embodiments of the disclosure will be described in detail in conjunction with the accompanying drawings. The contents of the disclosure may be applied to frequency division duplex (FDD), time division duplex (TDD), and cross division duplex (XDD) systems, As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling”, “PDCP signaling”, or “MAC control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed, for the sake of descriptive convenience, that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, embodiments of the disclosure will be described in detail in conjunction with the accompanying drawings. In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, a 5G system will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The contents of the disclosure may be applied to FDD and TDD systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

### [Random Access Procedure in SBFD]

Meanwhile, there has been ongoing discussion about subband full duplex (SBFD) as a new duplex scheme based on NR in 3GPP. The SBFD refers to a technology wherein a part of the downlink resource is used as the uplink resource in a TDD spectrum at a frequency of 6 GHz or less or at a frequency of 6 GHz or higher such that uplink transmission is received from a UE as much as the increased uplink resource, thereby expanding the UE's uplink coverage, and feedback regarding downlink transmission is received from the UE in the expanded uplink resource, thereby reducing feedback delay. In the disclosure, a UE capable of receiving information regarding whether SBFD is supported from the gNB, and capable of performing uplink transmission in a part of the downlink resource may be referred to as an SBFD-capable UE for convenience of description. In order to define the SBFD scheme in specifications and to determine that the SBFD-capable UE supports SBFD in a specific cell (or frequency/frequency band), the following schemes may be considered:
In the first scheme, besides the frame structure type of the existing unpaired spectrum (or time division duplex (TDD)) or paired spectrum (or frequency division duplex (FDD)), a different frame structure type (for example, frame structure type 2) may be introduced to define the above-described SBFD. Frame structure type 2 may be defined to be supported at a specific frequency or frequency band. Alternatively, the gNB may indicate whether SBFD is supported to the UE through system information. The SBFD-capable UE may receive the system information indicating whether SBFD is supported and may thus determine whether SBFD is supported in a specific cell (or frequency/frequency band).
In the second scheme, without defining a new frame structure type, it may be indicated whether SBFD is additionally supported at a specific frequency or frequency band of the existing unpaired spectrum (or TDD). According to the second scheme, it may be defined whether SBFD is additionally supported at a specific frequency or frequency band of the existing unpaired spectrum, or the gNB may indicate whether SBFD is supported to the UE through system information. The SBFD-capable UE may receive the system information indicating whether SBFD is supported and may thus determine whether SBFD is supported in a specific cell (or frequency/frequency band).

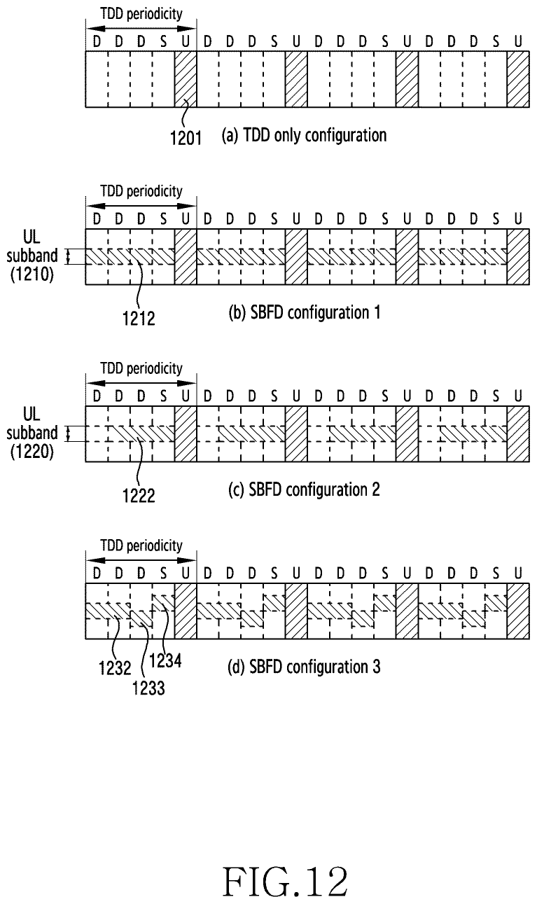

The information indicating whether SBFD is supported in the first and second schemes described above may additionally include information indirectly indicating whether SBFD is supported by configuring a part of the downlink resource as the uplink resource (for example, SBFD resource configuration information described later with reference to FIG. 12) besides a configuration regarding TDD uplink (UL)-downlink (DL) resource configuration information indicating TDD's downlink slot (or symbol) resource and uplink slot (or symbol) resource, or may include information directly indicating whether SBFD is supported.

In the disclosure, the SBFD-capable UE may acquire cell synchronization by receiving a synchronization signal block during an initial cell access for accessing a cell (or gNB). The process of acquiring cell synchronization may be equally applied to the SBFD-capable UE and existing TDD terminals. Thereafter, the SBFD-capable UE may determine whether the cell supports SBFD through an MIB acquisition, SIB acquisition, or random access process.

According to an embodiment, system information for transmitting information regarding whether SBFD is supported may be distinguished from system information for a UE (for example, existing TDD UE) supporting a different version of specifications in the cell and transmitted separately. The SBFD-capable UE may acquire all or part of the system information transmitted separately from the system information for the existing TDD UE, thereby determining whether SBFD is supported. In case that the SBFD-capable UE acquires only the system information for the existing TDD UE, or in case that the SBFD-capable UE acquires system information indicating that SBFD is not supported, the SBFD-capable UE may determine that the cell (or gNB) supports only TDD.

According to an embodiment, in case that information regarding whether SBFD is supported is included in system information for a UE (for example, existing TDD UE) supporting a different version of specifications, the information regarding whether SBFD is supported may be inserted at the last portion so as not to affect acquisition of the existing TDD UE's system information. In case that the SBFD-capable UE fails to acquire the information regarding whether SBFD is supported, which is inserted at the last portion, or in case that the SBFD-capable UE acquires information indicating that SBFD is not supported, the SBFD-capable UE may determine that the cell (or gNB) supports only TDD.

According to an embodiment, in case that information regarding whether SBFD is supported is included in system information for a UE (for example, existing TDD UE) supporting a different version of specifications, the information regarding whether SBFD is supported may be transmitted through a separate PDSCH so as not to affect acquisition of the existing TDD UE's system information. For example, a UE that does not support SBFD may receive a first SIB (or SIB1) including existing TDD-related system information in a first PDSCH. AUE that supports SBFD may receive a first SIB (or SIB) including existing TDD-related system information in a first PDSCH, and may receive a second SIB including SBFD-related system information in a second PDSCH. The first PDSCH and the second PDSCH may be scheduled by a first PDCCH and a second PDCCH, and the cyclic redundancy code (CRC) of the first PDCCH and the second PDCCH may be scrambled by the same RNTI (for example, SI-RNTI). The search space for monitoring the second PDCCH may be acquired from the first PDCCH's system information and, if the same fails to be acquired (for example, if the first PDCCH's system information does not include information regarding the search space), the second PDCCH may be received in the same search space as the first PDCCH's search space.

In case that the SBFD-capable UE determines that the cell (or gNB) supports only TDD as described above, the SBFD-capable UE may perform the same random access procedure and data/control signal transmission/reception as the existing TDD UE.

According to various embodiments, the gNB may configure a separate random access resource for each of the existing TDD UE or SBFD-capable UE (for example, including both an SBFD-capable UE supporting duplex communication and an SBFD-capable UE supporting half-duplex communication), and may transmit configuration information (configuration information or control information indicating a time-frequency resource that may be used for the PRACH) regarding the random access resource to the SBFD-capable UE through system information. System information for transmitting information regarding a random access resource may include system information distinguished from system information for a UE (for example, existing TDD UE) supporting a different version of specifications in the cell and transmitted separately.

According to various embodiments of the disclosure, the gNB may configure a random access resource for the TDD UE, and may additionally configure a separate random access resource for the SBFD-capable UE. The SBFD-capable UE may be able to use the random access resource for the TDD UE or may be unable to use the random access resource for the TDD UE. In the latter case, the SBFD-capable UE may always use only the separate random access resource for the SBFD-capable UE.

According to an embodiment, the SBFD-capable UE may receive an indication regarding whether the random access resource for the TDD UE is available from the gNB. Such an indication may be included in an SIB and then received. For example, the SIB may configure a separate random access resource for the SBFD-capable UE and may indicate, together with the configuration, whether the random access resource for the TDD UE is available. Such an indication may be made through one-bit information. According to an embodiment, if the one-bit information is “0” (or FALSE), the SBFD-capable UE may be unable to use the random access resource for the TDD UE. Alternatively, if the one-bit information is “1” (or TRUE), the SBFD-capable UE may be able to use the random access resource for the TDD UE. According to various embodiments, this is only an example and, obviously, the opposite case may also be included.

According to an embodiment, the gNB may determine the type of a UE which attempts to access a cell, based on the random access resource used by the UE. For example, the SBFD-capable UE may transmit a PRACH through a separate random access resource for the SBFD-capable UE. The gNB may receive the PRACH transmitted by the SBFD-capable UE and may determine that the SBFD-capable UE is attempting a cell access. For example, in case that a TDD UE transmits a PRACH through a random access resource for the TDD UE, the gNB may receive the PRACH and may determine that the TDD UE is attempting a cell access. In case that the SBFD-capable UE is allowed to transmit a PRACH through the random access resource of the TDD UE, the gNB may be uncertain about whether the type of the UE that has transmitted the PRACH is a TDD UE or an SBFD-capable UE. In this case, the gNB may assume that the type of the UE described above is always a TDD UE.

According to an embodiment, in case that the gNB has determined that the relevant UE is an SBFD-capable UE, the gNB may schedule msg2, msg3, msg4, or the like for the UE, based on an uplink subband configuration. For example, when the gNB schedules reception of msg2 and msg4 for the UE, the gNB may schedule msg2 and msg4 so as not to be received in the uplink subband (for example, when the UE receives a PDSCH including msg2 and msg4, the UE receives the PDSCH in a frequency resource other than the uplink subband). Alternatively, when the gNB schedules a msg3 PUSCH, the gNB may schedule the msg3 PUSCH so as to be transmitted in the uplink subband.

According to an embodiment, in case that the gNB has determined that the relevant UE is a TDD UE, the gNB may be unable to use the uplink subband configuration when scheduling msg2, msg3, msg4, or the like for the UE. For example, even if the uplink subband is configured for a downlink symbol or flexible symbol, the gNB may assume that the UE cannot acquire the configured uplink subband configuration information. When scheduling a msg3 PUSCH for the UE, the gNB may schedule the msg3 PUSCH for a flexible symbol or uplink symbol. In other words, the msg3 PUSCH cannot be scheduled for the uplink subband.

According to various embodiments of the disclosure, the gNB may not configure a separate random access resource for the SBFD-capable UE, and may configure a common random access resource for all UEs in the cell. In this case, configuration information regarding the random access resource may be transmitted to all UEs in the cell through system information and, upon receiving such system information, the SBFD-capable UE may perform a random access with regard to the configured random access resource. Thereafter, the SBFD-capable UE may complete the random access process and may proceed to an RRC connected mode for transmitting/receiving data with the cell. After the RRC connected mode, the SBFD-capable UE may receive an upper or physical signal from the gNB, thereby determining that a part of the frequency resource of the downlink time resource is configured as an uplink resource, and may accordingly perform an SBFD operation (for example, transmit an uplink signal in the configured uplink resource).

According to an embodiment, in case of determining that the cell supports SBFD, the SBFD-capable UE may transmit, to the gNB, capability information including at least one from among information regarding whether the UE supports SBFD, information regarding whether full-duplex communication or half-duplex communication is supported, or the number of transmission or reception antennas which the same has (or supports), thereby informing the gNB that the UE that attempts an access is the SBFD-capable UE. According to an embodiment, in case that the SBFD-capable UE is required to implement half-duplex communication, the capability information may obviously not include information regarding whether half-duplex communication is supported. The SBFD-capable UE may report capability information to the gNB through a random access process, may separately report the same to the gNB after completing the random access process, or may report the same to the gNB after proceeding to an RRD connected mode for transmitting/receiving data with the cell.

According to an embodiment, the SBFD-capable UE may support half-duplex communication such that uplink transmission or downlink reception is solely performed at a specific moment like an existing TDD UE, or may support full-duplex communication such that uplink transmission and downlink reception are both performed at a specific moment. Therefore, the SBFD-capable UE may report whether the half-duplex communication or the full-duplex communication is supported through capability information, and the gNB may configure, after the reporting, the SBFD-capable UE so as to perform transmission/reception by using the half-duplex communication or by using the full-duplex communication. In case that the SBFD-capable UE reports capability regarding half-duplex communication to the gNB, a switching gap may be required to change the RF between transmission and reception, when operating according to FDD of TDD, because no duplexer exists generally.

According to an embodiment, a UE may generally form a radio link with a network through a random access procedure, based on system information and synchronization with the network acquired in a cell search process. A contention-based random access scheme or a contention-free random access scheme may be used. The contention-based random access scheme may be used in case that the UE performs cell selection and reselection in the initial cell access phase (for example, in case that the UE transitions from an RRC_IDLE state to an RRC_CONNECTED state), or for other purposes. The contention-free random access may be used to reconfigure uplink synchronization in case that downlink data has arrived, in the case of a handover, or in the case of position measurement.

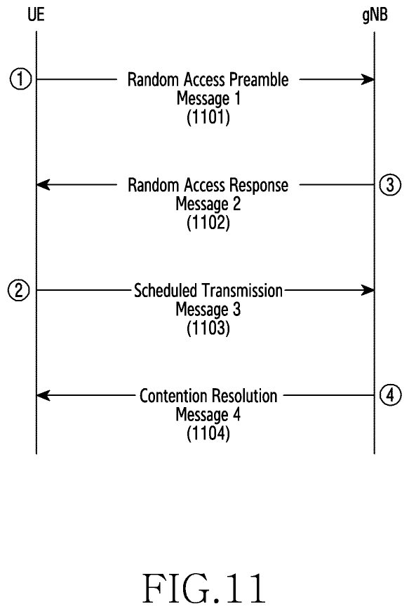

FIG. 11 illustrates an example of a random access procedure according to an embodiment of the disclosure. More specifically, FIG. 11 illustrates a random access procedure in a wireless communication system.

FIG. 11 illustrates a contention-based random access procedure according to an embodiment. In addition, although not illustrated in FIG. 11, the gNB may transmit a synchronization signal block as described above. The gNB may periodically transmit the synchronization signal block by using beam sweeping. For example, the gNB may transmit a synchronization signal block (for example, SS/PBCH (SSB) block) including a primary synchronization signal (PSS)/secondary synchronization signal (SSS) and a physical broadcasting channel (PBCH) signal by using a maximum of 64 different beams for 5 ms, and multiple synchronization signal blocks may be transmitted by using different beams. The UE may detect (select) a synchronization signal block having an optimal beam direction (for example, a beam direction in which the received signal strength is the highest or above a predetermined threshold), and may transmit a preamble by using a physical random access channel (PRACH) resource related to the detected synchronization signal block. For example, in the first step 1101 of the random access procedure, the UE may transmit a random access preamble (or message 1) to the gNB. Upon receiving the random access preamble, the gNB may measure the transmission delay value between the UE and the gNB, and may make uplink synchronization. Specifically, the UE may transmit a random access preamble selected arbitrarily from a random access preamble set given by system information in advance. The initial transmission power of the random access preamble may be determined according to the pathloss between the gNB and the UE, measured by the UE. In addition, the UE may determine the transmission beam direction (or transmission beam or beam) of the random access preamble, based on a synchronization signal block received from the gNB, and may transmit the random access preamble by applying the determined transmission beam direction.

In the second step 1102, the gNB may transmit a random access response (RAR) or message 2 (msg2)) to the UE in response to a detected random access attempt. The gNB may transmit an uplink transmission timing control command to the UE from the transmission delay value measured based on the random access preamble received in the first step. In addition, the gNB may transmit a power control command and an uplink resource to be used by the UE, as scheduling information. The scheduling information transmitted by the gNB may include control information regarding the UE's uplink transmission beam. The RAR may be transmitted through a PDSCH and may include at least one of the following pieces of information:
A random access preamble sequence index detected by the network (or gNB)
A temporary cell radio network temporary identifier (TC-RNTI)
A uplink scheduling grant
A timing advance value

According to an embodiment, in case that the UE fails to receive scheduling information (RAR) regarding message 3 from the gNB for a predetermined time in the second step 1102, the UE may proceed back to the first step 1101. When proceeding back to the first step 1101, the UE may transmit the random access preamble with transmission power increased by a predetermined step (for example, power ramping), thereby increasing the probability that the gNB will receive the random access preamble.

In the third step 1103, the UE may transmit uplink information (for example, scheduled transmission or message 3) including its UE identifier (for example, UE contention resolution identity) (or if the UE already has an effective UE identifier (C-RNTI) in the cell before initiating a random access procedure, that effective UE identifier) to the gNB through a physical uplink shared channel (PUSCH) by using the uplink resource allocated in the second step 1102. The PUSCH may be referred to as a msg3 PUSCH. The transmission timing of the PUSCH for transmitting message 3 may follow the uplink transmission timing control command received from the gNB in the second step 1102. In addition, the transmission power of the PUSCH for transmitting message 3 may be determined in consideration of the power ramping value of the random access preamble and the power control command received from the gNB in the second step 1102. The PUSCH for transmitting message 3 may include the first uplink data signal transmitted from the UE to the gNB after the random access preamble is transmitted by the UE.

In the fourth step 1104, in case of determining that the UE has performed a random access without contention with other UEs, the gNB may transmit a message (for example, contention resolution (CR) message or message 4) including the identifier of the UE which has transmitted uplink data in the third step 1103. In this connection, in case that multiple UEs have received the same TC-RNTI in the second step 1102, each of the multiple UEs that have received the same TC-RNTI may transmit message 3 including the UE identifier (UE contention resolution identity) to the gNB in the third step 1103, and the gNB may transmit message 4 (CR message) including one of identifiers of the multiple UEs in order to resolve contention. In case that the UE receives message 4 (CR message) including its UE identifier from the gNB in the fourth step 1104 (or in case that the UE has transmitted message 3 including the C-RNTI in the third step 1103 and has received UE-specific control information including a cyclic redundancy check (CRC) based on the C-RNTI through a PDCCH in the fourth step 1104), the UE may determine that the random access is successful. Therefore, among multiple UEs that have receive the same TC-RNTI from the gNB, a UE that has identified that its UE identifier is included in message 4 (CR message) may identify that it has succeeded in contention. The UE may transmit a HARQ-ACK/negative acknowledgment (NACK) to the gNB through a physical uplink control channel (PUCCH) to indicate whether message 4 has been received successfully.

According to an embodiment, in case that data transmitted by the UE in the third step 1103 has contended with data from another UE, and the gNB has thus failed to receive data signals from the UE, the gNB may no longer transmit data to the UE. Accordingly, in case that the UE fails to receive data transmitted from the gNB in the fourth step 1104 during a predetermined time interval, the UE may determine that the random access procedure has failed and may restart form the first step 1101.

As described above, in the first step 1101 of the random access process, the UE may transmit a random access preamble through a PRACH. Each cell has 64 available preamble sequences, and four types of long preamble formats and nine short preamble formats may be used according to the transmission type. The UE may generate 64 preamble sequences by using a cyclic shift value and a root sequence index signaled by system information, may randomly select one sequence, and may use the same as a preamble.

According to an embodiment, the gNB may provide the UE with configuration information regarding a random access resource (for example, control information (or configuration information) indicating a time-frequency resource that may be used for a PRACH) by using at least from among an SIB, upper layer signaling (radio resource control (RRC) information), or downlink control information (DCI). The frequency resource for PRACH transmission may indicate, to the UE, the RB point at which transmission starts, and the number of used RBs may be determined according to the applied subcarrier spacing and the preamble format transmitted through the PRACH. The time resource for PRACH transmission may inform of a preconfigured PRACH configuration period, a subframe index including a PRACH transmission timepoint (which may be used interchangeably with a PRACH occasion, a transmission timepoint, or the like), a starting symbol, or the number of PRACH transmission timepoints in a slot, and the like through a PRACH configuration index (for example, 0 to 255) as in [Table 16] below. The UE may determine the validity regarding PRACH transmission timepoints indicated by the PRACH configuration index, and may determine that valid PRACH transmission timepoints are solely PRACH transmission timepoints at which a random access preamble may be transmitted. Through the PRACH configuration index, random access configuration information included in the SIB, and the index of the SSB selected by the UE, the UE may identify the time and frequency resources to be used to transmit a random access preamble, and may transmit the selected sequence to the gNB as a preamble.

TABLE 16

| PRACH | | | | | | | number of time-domain | |
|---|---|---|---|---|---|---|---|---|
| configuration | Preamble | | | Subframe | | Number of PRACH slots | PRACH occasions within | |
| Index | format | [symbol] | | number | Starting symbol | within a subframe | a PRACH slot | PRACH duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| . . . | . . . | | | | | | | |
| 104 | A1 | 1 | 0 | 1, 4, 7 | 0 | 2 | 6 | 2 |
| . . . | . . . | | | | | | | |
| 251 | C | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | | 2 | 2 | 6 |
| 254 | C2 | 1 | 0 | 0, 1, 2, 3, 4, 5, 6, | 0 | 2 | 2 | 6 |
| | | | | 7, 8, 9 | | | | |
| 255 | C2 | 1 | 0 | 1, 3, 5, 7, 9 | 0 | 2 | 2 | 6 |

[symbol]

indicates data missing or illegible when filed

Meanwhile, according to an embodiment of the disclosure, there is a need for a scheme in which an SBFD-capable UE determines the validity of a PRACH transmission timepoint through an SBFD configuration and a PRACH configuration index for performing PRACH transmission, and performs PRACH transmission through a PRACH transmission timepoint deemed to be valid, or a scheme of a procedure performed by the SBFD-capable UE if the valid PRACH transmission timepoint and downlink reception overlap.

Therefore, a method in which the SBFD-capable UE determines the validity of a PRACH transmission timepoint, and SBFD-capable UE operations in case a valid PRACH transmission timepoint and downlink reception are configured or scheduled to occur simultaneously will be described with reference to the following drawings.

FIG. 12 illustrates examples of a time division duplex (TDD) configuration and a subband full duplex (SBFD) configuration according to various embodiments of the disclosure. More specifically, FIG. 12 illustrates an example of operating SBFD in a TDD spectrum of a wireless communication system to which the disclosure is applied.

(a) of FIG. 12 illustrates a case of operating TDD in a specific frequency band. A gNB in a cell that operates TDD may transmit/receive signals including data/control information with an existing TDD UE or SBFD-capable UE in a downlink slot (or symbol), an uplink slot (or symbol) 1201, or a flexible slot (or symbol), based on a configuration that follows TDD UL-DL resource configuration information that indicates TDD's downlink slot (or symbol) resource and uplink slot (or symbol) resource.

According to an embodiment, it may be assumed that a DDDSU slot format is configured according to TDD UL-DL resource configuration information in FIG. 12. In this regard, “D” may refer to a slot entirely configured by downlink symbols, “U” may refer to a slot entirely configured by uplink symbols, and “S” may refer to a slot which is neither “D” nor “U” (for example, a slot including downlink symbols or uplink symbols or including flexible symbols). It may be assumed for convenience that “S” is configured by 12 downlink symbols and 2 flexible symbols, but this is only an example and is not limitative. The DDDSU slot format may be repeated according to the TDD UL-DL resource configuration information. For example, the TDD configuration's repetition period may include 5 slots (for example, in the case of 15 kHz SCS, 5 ms, in the case of 30 kHz SCS, 2.5 ms).

Next, (b) of FIG. 12, (b) of FIG. 12, and (d) of FIG. 12 illustrate a case in which SBFD is operated together with TDD in a specific frequency band.

Referring to (b) of FIG. 12, the UE may have a partial frequency band of the cell configured as a frequency band 1210 in which uplink transmission is possible. Such a band may be referred to as a UL subband. The UL subband may be applied to all symbols of all slots. The UE may transmit a scheduled uplink channel or signal at all symbols 1212 in the UL subband. However, the UE cannot transmit uplink channels or signals in band other than the UL subband.

Referring to (c) of FIG. 12, the UE may have a partial frequency band of the cell configured as a frequency band 1220 in which uplink transmission is possible, and may have a configured time area in which a frequency band is activated. Such a frequency band may be referred to as a UL subband. Referring to (c) of FIG. 12, the UL subband on the first slot may be deactivated, and the UL subband on remaining slots may be activated. Therefore, the UE may transmit uplink channels or signals on the UL subband 1222 of remaining slots. That is, (c) of FIG. 12 illustrates an example in which the UL subband is activated with regard to each slot, but this is only an example, and it is obvious that activation/deactivation may be configured with regard to each symbol.

Referring to (d) of FIG. 12, the UE may have a configured time-frequency resource in which uplink transmission is possible. The UE may have one or more time-frequency resources configured as time-frequency resources in which uplink transmission is possible. For example, a partial frequency band 1232 of the first and second slots may be configured for the UE as a time-frequency resource in which uplink transmission is possible. In addition, a partial frequency band 1233 of the third slot and a partial frequency band 1234 of the fourth slot may be configured for the UE as a time-frequency resource in which uplink transmission is possible.

In the following description, a time-frequency resource in which uplink transmission is possible at a downlink symbol or flexible symbol may be referred to as an SBFD resource/UL subband.

### Embodiment 1: Method for Determining a Valid RACH Occasion

According to various embodiments of the disclosure, the gNB may transmit a first PRACH configuration to the UE through system information, and RACH occasions may be configured according to the first PRACH configuration. The UE may determine that all or some of the RACH occasions are valid. The first PRACH configuration may be a PRACH configuration for a TDD UE. Therefore, when determining valid RACH occasions according to the first PRACH configuration, the TDD UE may be unable to use configuration information regarding SBFD resources or UL subbands.

According to an embodiment, in an FDD cell, all RACH occasions that follow a configured first PRACH configuration may be defined as valid. The valid RACH occasions may be defined as first valid RACH occasions (ROs).

According to an embodiment, in a TDD cell, only RACH occasions that satisfy the following condition, among the configured first PRACH configuration, may be valid. The valid RACH occasions may be defined as first valid RACH occasions (ROs).

According to an embodiment, in case that the UE has received no TDD DL/UL configuration information through system information, and in case that a RACH occasion does not precede an SS/PBCH in a PRACH slot and starts after N_gap symbols from the last reception symbol of the SS/PBCH, the UE may determine that the RACH occasion is valid.

According to an embodiment, in case that the UE has received TDD DL/UL configuration information through system information, in case that a RACH occasion does not precede an SS/PBCH in a RACH occasion or PRACH slot inside a UL symbol and starts after N_gap symbols from the last reception symbol of the SS/PBCH, and in case that N_gap symbols start from the last DL symbol, the UE may determine that the RACH occasion is valid.

According to an embodiment, the value of N_gap may be determined according to the subcarrier spacing of a preamble and a PRACH preamble format. For example, in the case of preamble format B4, N_gap=0. In the case of other preamble formats, N_gap=0 if the subcarrier spacing is 1.25 kHz or 5 kHz, or N_gap=2 if the subcarrier spacing is 15 kHz, 30 kHz, 60 kHz or 120 kHz. N_gap=8 if the subcarrier spacing is 480 kHz, or N_gap=16 if the subcarrier spacing is 960 KHz.

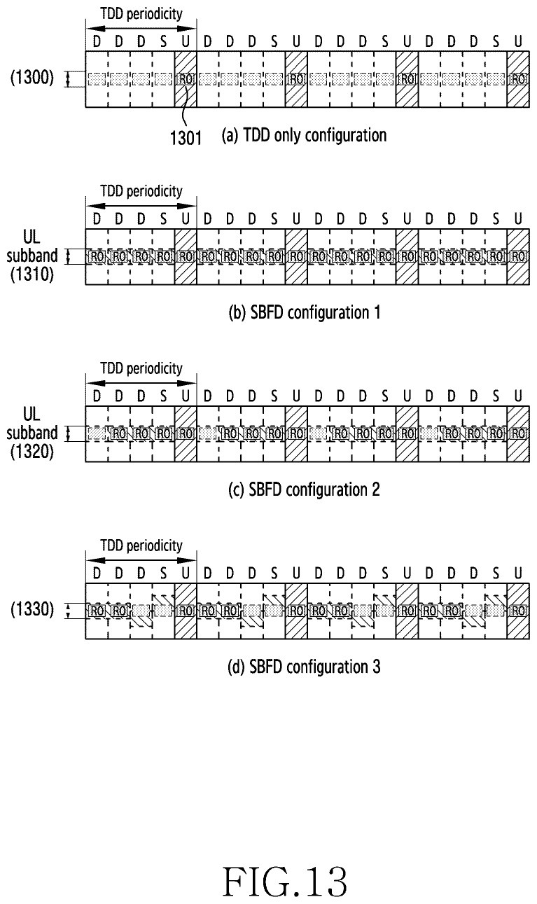

FIG. 13 illustrates an example of a valid RACH occasion in connection with a TDD configuration and an SBFD configuration according to various embodiments of the disclosure. More specifically, FIG. 13 illustrates first valid RACH occasions in a TDD cell.

According to various embodiments of the disclosure, referring to (a) of FIG. 13, it may be assumed that DDDSU is configured for the UE through TDD DL/UL configuration information, and each slot RACH occasion is configured according to a first PRACH configuration. The UE may determine that, among RACH occasions determined according to the first PRACH configuration, occasions overlapping with a UL symbol are valid RACH occasions. The fifth slot (for example, the last slot of a TDD period configured as DDDSU) is an uplink slot, and the RACH occasion 1301 may be valid. However, the RACH occasion of the first, second, third, and fourth slots (for example, preceding four slots of the TDD period configured as DDDSU) does not start after N_gap symbols from the last downlink symbol, and thus may be invalid. Therefore, the UE may determine that the RACH occasion of four uplink slots (for example, 5^{th}, 10^{th}, 15^{th}, and 20^{th}) in 20 slots is valid, and the RACH occasion of remaining 16 slots is invalid.

According to various embodiments of the disclosure, a SBFD-capable UE may determine the validity of a RACH occasion according to a second PRACH configuration. The second PRACH configuration may be a PRACH configuration for the SBFD-capable UE. The SBFD-capable UE may include a UE that may acquire resource configuration information regarding SBFD resources/UL subbands and a TDD DL/UL configuration. Therefore, when determining a RACH occasion according to the second PRACH configuration, the UE may use resource configuration information regarding SBFD resources/UL subbands and a TDD DL/UL configuration format. RACH occasions determined to be valid according to the second PRACH configuration may be referred to as second RACH occasions.

According to an embodiment of the disclosure, the SBFD-capable UE may determine the validity of a RACH occasion according to the second PRACH configuration as follows:

According to an embodiment, unless specifically mentioned otherwise in the following description, RACH occasions may include all RACH occasions included in a UL subband. In case that a part of the time and frequency of a RACH occasion is not included in the SBFD resource/UL subband, the RACH occasion may be invalid, according to the second PRACH configuration.

According to various embodiments of the disclosure, in the first method, the UE may determine a valid RACH occasion as follows:

According to an embodiment, in case that the UE has received no TDD DL/UL configuration information through system information, in case that a RACH occasion does not precede an SS/PBCH in a slot and starts after N_gap symbols from the last reception symbol of the SS/PBCH, and in case that the RACH occasion is positioned in the SBFD resource/UL subband, the UE may determine that the RACH occasion is valid.

According to an embodiment, in case that the UE has received TDD DL/UL configuration information through system information, in case that a RACH occasion or a RACH occasion in a slot including a UL symbol does not precede an SS/PBCH and starts after N_gap symbols from the last reception symbol of the SS/PBCH, and in case that the RACH occasion is positioned in the SBFD resource/UL subband, the UE may determine that the RACH occasion is valid.

According to various embodiments of the disclosure, in the second method, the UE may determine a valid RACH occasion as follows. Compared with the first method, even if the condition regarding the SS/PBCH is not satisfied, the UE may determine that the RACH occasion is valid.

According to an embodiment, in case that the UE has received no TDD DL/UL configuration information through system information, and in case that a RACH occasion is positioned in the SBFD resource/UL subband, the UE may determine that the RACH occasion is valid.

According to an embodiment, in case that the UE has received TDD DL/UL configuration information through system information, and in case that a RACH occasion or a RACH occasion in a UL symbol is positioned in the SBFD resource/UL subband, the UE may determine that the RACH occasion is valid.

According to various embodiments of the disclosure, in the third method, the UE may determine a valid RACH occasion as follows. Compared with the first method, even if SS/PBCH conditions other than RACHs preceding the SS/PBCH are not satisfied, the UE may determine that the RACH occasion is valid.

According to an embodiment, in case that the UE has received no TDD DL/UL configuration information through system information, in case that a RACH occasion does not precede the SS/PBCH, and in case that the RACH occasion is positioned in the SBFD resource/UL subband, the UE may determine that the RACH occasion is valid.

According to an embodiment, in case that the UE has received TDD DL/UL configuration information through system information, in case that a RACH occasion in a UL symbol or a RACH occasion in a slot does not precede the SS/PBCH, and in case that the RACH occasion is positioned in the SBFD resource/UL subband, the UE may determine that the RACH occasion is valid.

According to an embodiment, the SBFD-capable UE may determine second valid RACH occasion in a UL symbol in the first, second, or third method according to the second PRACH configuration. The UE may determine first valid RACH occasion in a UL symbol according to the first PRACH configuration. Therefore, according to the first, second, or third method, the UE may determine a first valid RACH occasion and a second valid RACH occasion in the same UL symbol. This may be referred to as valid RACH occasions overlapped in the UL symbol.

According to an embodiment, the SBFD-capable UE may exclude ROs in the UL symbol when determining a second valid PRACH occasion according to the second PRACH configuration. For example, the UE may prevent valid RACH occasions overlapped in the UL symbol.

More specifically, methods of the disclosure are as follows:

According to various embodiments of the disclosure, in the fourth method, the UE may determine a valid RACH occasion as follows.

According to an embodiment, in case that the UE has received no TDD DL/UL configuration information through system information, in case that a RACH occasion does not precede an SS/PBCH in a slot and starts after N_gap symbols from the last reception symbol of the SS/PBCH, and in case that the RACH occasion is positioned in the SBFD resource/UL subband, the UE may determine that the RACH occasion is valid.

According to an embodiment, in case that the UE has received TDD DL/UL configuration information through system information, in case that a RACH occasion does not precede an SS/PBCH and starts after N_gap symbols from the last reception symbol of the SS/PBCH, and in case that the RACH occasion is positioned in the SBFD resource/UL subband, the UE may determine that the RACH occasion is valid.

According to various embodiments of the disclosure, in the fifth method, the UE may determine a valid RACH occasion as follows. Compared with the first method, even if the condition regarding the SS/PBCH is not satisfied, the UE may determine that the RACH occasion is valid.

According to an embodiment, in case that the UE has received no TDD DL/UL configuration information through system information, and in case that a RACH occasion is positioned in the SBFD resource/UL subband, the UE may determine that the RACH occasion is valid.

According to an embodiment, in case that the UE has received TDD DL/UL configuration information through system information, and in case that a RACH occasion in a UL symbol is positioned in the SBFD resource/UL subband, the UE may determine that the RACH occasion is valid.

According to various embodiments of the disclosure, in the sixth method, the UE may determine a valid RACH occasion as follows. Compared with the first method, even if SS/PBCH conditions other than RACHs preceding the SS/PBCH are not satisfied, the UE may determine that the RACH occasion is valid.

According to an embodiment, in case that the UE has received no TDD DL/UL configuration information through system information, in case that a RACH occasion does not precede the SS/PBCH in a slot, and in case that the RACH occasion is positioned in the SBFD resource/UL subband, the UE may determine that the RACH occasion is valid.

According to an embodiment, in case that the UE has received TDD DL/UL configuration information through system information, in case that a RACH occasion in a slot does not precede the SS/PBCH, and in case that the RACH occasion is positioned in the SBFD resource/UL subband, the UE may determine that the RACH occasion is valid.

According to an embodiment, in the above-described methods, the SBFD resource/UL subband may be configured only in a downlink symbol and a flexible symbol. For example, the SBFD resource/UL subband may not be configured in an uplink symbol. Even if the SBFD resource/UL subband is configured in an uplink symbol, the SBFD resource/UL subband of the above methods may be limited to an SBFD resource/UL subband configured in a downlink symbol and a flexible symbol.

According to an embodiment, the SBFD-capable UE may determine second valid RACH occasion in a DL symbol or flexible symbol in the fourth, fifth, or sixth method according to the second PRACH configuration. For example, no second valid RACH occasion may be determined in the UL symbol. According to the first PRACH configuration, first valid RACH occasions may be determined in the flexible symbol. Therefore, according to the fourth, fifth, or sixth method, the UE may determine a first valid RACH occasion and a second valid RACH occasion in the same flexible symbol. This may be referred to as valid RACH occasions overlapped in the flexible symbol.

According to an embodiment, the SBFD-capable UE may exclude ROs in the UL symbol and flexible symbol when determining a second valid PRACH occasion according to the second PRACH configuration. For example, the UE may prevent valid RACH occasions overlapped in the UL symbol and valid RACH occasions overlapped in the flexible symbol.

More specifically, methods of the disclosure are as follows:

According to various embodiments of the disclosure, in the seventh method, the UE may determine a valid RACH occasion as follows.

According to an embodiment, in case that the UE has received no TDD DL/UL configuration information through system information, in case that a RACH occasion does not precede an SS/PBCH in a slot and starts after N_gap symbols from the last reception symbol of the SS/PBCH, and in case that the RACH occasion is positioned in the SBFD resource/UL subband of the downlink symbol, the UE may determine that the RACH occasion is valid.

According to an embodiment, in case that the UE has received TDD DL/UL configuration information through system information, in case that a RACH occasion does not precede an SS/PBCH and starts after N_gap symbols from the last reception symbol of the SS/PBCH, and in case that the RACH occasion is positioned in the SBFD resource/UL subband of the downlink symbol, the UE may determine that the RACH occasion is valid.

According to various embodiments of the disclosure, in the eighth method, the UE may determine a valid RACH occasion as follows. Compared with the seventh method, even if the condition regarding the SS/PBCH is not satisfied, the UE may determine that the RACH occasion is valid.

According to an embodiment, in case that the UE has received no TDD DL/UL configuration information through system information, and in case that a RACH occasion is positioned in the SBFD resource/UL subband of the downlink symbol, the UE may determine that the RACH occasion is valid.

According to an embodiment, in case that the UE has received TDD DL/UL configuration information through system information, and in case that a RACH occasion in a UL symbol is positioned in the SBFD resource/UL subband of the downlink symbol, the UE may determine that the RACH occasion is valid.

According to various embodiments of the disclosure, in the ninth method, the UE may determine a valid RACH occasion as follows. Compared with the seventh method, even if SS/PBCH conditions other than RACHs preceding the SS/PBCH are not satisfied, the UE may determine that the RACH occasion is valid.

According to an embodiment, in case that the UE has received no TDD DL/UL configuration information through system information, in case that a RACH occasion does not precede the SS/PBCH in a slot, and in case that the RACH occasion is positioned in the SBFD resource/UL subband of the downlink symbol, the UE may determine that the RACH occasion is valid.

According to an embodiment, in case that the UE has received TDD DL/UL configuration information through system information, in case that a RACH occasion does not precede the SS/PBCH in a slot, and in case that the RACH occasion is positioned in the SBFD resource/UL subband of the downlink symbol, the UE may determine that the RACH occasion is valid.

According to various embodiments of the disclosure, according to the seventh, eighth, or ninth method, second valid RACH occasions may not overlap with first valid RACH occasions in the same symbol. However, first valid RACH occasions and second valid RACH occasions may overlap in one slot of the UE. In other words, first valid RACH occasions and second valid RACH occasions may not overlap in the same symbol, but may be included in the same slot. Methods for preventing this may be described.

According to various embodiments of the disclosure, in an embodiment of the method, at least one of the following operations may be added when the UE determines second valid RACH occasions.

According to an embodiment, in case that a first valid RACH occasion is determined in a slot, the UE may not determine a second valid RACH occasion in the slot. For example, the UE may determine that all second RACH occasions of the slot are invalid. The UE may give priority regarding the slot to the first valid RACH occasion.

According to an embodiment, in case that a second valid RACH occasion is determined in a slot, the UE may not determine a first valid RACH occasion in the slot. For example, the UE may determine that all first RACH occasions of the slot are invalid. The UE may give priority regarding the slot to the second valid RACH occasion.

According to an embodiment, in case that a first RACH occasion (for example, RACH occasions prior to validity determination) is determined in a slot according to the first PRACH configuration, the UE may not determine a second valid RACH occasion in the slot. For example, the UE may determine that all second RACH occasions of the slot are invalid. The UE may give priority regarding the slot to the first valid RACH occasion.

According to an embodiment, in case that a second RACH occasion (for example, RACH occasions prior to validity determination) is determined in a slot according to the second PRACH configuration, the UE may not determine a first valid RACH occasion in the slot. For example, the UE may determine that all first RACH occasions of the slot are invalid. The UE may give priority regarding the slot to the second valid RACH occasion.

According to various embodiments of the disclosure, in the above-described methods, it may be determined as follows whether a RACH occasion precedes the SS/PBCH in a slot.

According to an embodiment, in case that the starting symbol of a RACH occasion precedes the starting symbol of the SS/PBCH, the RACH occasion may be deemed to precede the SS/PBCH.

According to an embodiment, in case that the last symbol of a RACH occasion precedes the starting symbol of the SS/PBCH, the RACH occasion may be deemed to precede the SS/PBCH.

### Embodiment 2: Method for Receiving Msg2 Regarding Overlapped RACH Occasions

As described above, when the SBFD-capable UE determine first valid RACH occasions according to the first PRACH configuration and determines second valid RACH occasions according to the second PRACH configuration, the first valid RACH occasions and the second valid RACH occasions may overlap in the time domain. This may be referred to as overlapped valid RACH occasions.

According to various embodiments of the disclosure, it may be assumed that the SBFD-capable UE has transmitted a PRACH preamble corresponding to one occasion (for convenience, the second valid RACH occasion) among overlapped valid RACH occasions. It may be assumed that a TDD UE or another SBFD-capable UE has transmitted a PRACH preamble corresponding to another occasion (for convenience, the first valid RACH occasion) among overlapped valid RACH occasions. In this case, the two UEs have transmitted a PRACH preamble through different valid RACH occasions, but may be unable to distinguish a PDCCH that schedules msg2 corresponding to the PRACH preamble.

According to an embodiment, more specifically, the CRC of the PDCCH that schedules msg2 may be scrambled by a RA-RNTI. The RA-RNTI may have a value determined according to the valid RACH occasion corresponding to the PRACH preamble transmitted by the UE. As an example, the RA-RNTI may be determined as follows:

$$RA - RNTI = 1 + s\_id + 14 \times t\_id + 14 \times 80 \times f\_id + 14 \times 80 \times 8 \times ul\_carrier \_id \qquad Equation 2$$

wherein s_id, t_id, f_id, and ul_carrier_id may be determined as follows:
s_id: Index of the first OFDM symbol of the specified PRACH (0≤s_id<14)
t_id: Index of the first slot of the specified PRACH in a system frame (0≤t_id<80)
f_id: Index of the specified PRACH in the frequency domain (0≤f_id<8)
ul_carrier_id: Uplink carrier used for Msg1 transmission (0 for NUL carrier, and 1 for SUL carrier)

According to an embodiment, according to Equation 2, if overlapped valid RACH occasions start at the same starting OFDM symbol (for example, the same s_id), are positioned in the same slot (for example, the same t_id), are positioned at the same frequency index (for example, the same f_id), and are transmitted through the same carrier (for example, the same ul_carrier_id), the same RA-RNTI may correspond thereto. Therefore, UEs cannot be distinguished through the RA-RNTI. Various methods for solving this may be disclosed.

### <First Method: Introducing a New Offset Value to RNTI>

According to an embodiment, in the first method, the RA-RNTI may be updated by a new calculation equation. For reference, the RA-RNTI will have the same name even if updated by a new calculation equation, the RA-RNTI may obviously be referred to as different names (for example, SBFD-RA-RNTI). After transmitting a preamble corresponding to a second valid RACH occasion determined according to the second PRACH configuration, the SBFD-capable UE may calculate the RA-RNTI updated by a new calculation equation. The SBFD-capable UE may receive a PDCCH that schedules msg2 by using the RA-RNTI.

The calculation equation of the RA-RNTI may be updated according to the first method as in Equation 3 below:

$$RA - RNTI = 1 + s\_id + 14 * t\_id + 14 * 80 * f\_id + 14 * 80 * 8 * ul\_carrier \_id + Offset \qquad Equation 3$$

The definition of s_id, t_id, f_id, and ul_carrier_id may be the same as in Equation 2. According to an embodiment, Offset may be an offset value as follows:

According to an embodiment, the value of Offset may be determined to be 1+13+14*79+14*80*7+14*80*8*1=17,920 which is the maximum value among values that RA-RNTI may conventionally have. The maximum value may be determined by applying s_id=13, t_id=79, f_id=7, and ul_carrier_id=1. Alternatively, the maximum value may be 14*80*8*2=17,920.

According to an embodiment, the value of Offset may be determined to be 1+13+14*79+14*80*7+14*80*8*2=26,880 which is the maximum value among values that msgB-RNTI may conventionally have. The msgB-RNTI, which is the RNTI value for receiving msgB in a two-step RACH procedure, may be calculated as in Equation 4 below:

$$msgB - RNTI = 1 + {s}_{id} + 14 * {t}_{id} + 14 * 80 * {f}_{id} + 14 * 80 * 8 * {ul}_{{carrier}_{id}} + 14 * 80 * 8 * 2 \qquad Equation 4$$

The definition of s_id, t_id, f_id, and ul_carrier_id may be the same as in Equation 2. The maximum value may be determined to be 1+13+14*79+14*80*7+14*80*8*2=26,880 by applying s_id=13, t_id=79, f_id=7, and ul_carrier_id=1 to the msgB-RNTI equation. Alternatively, the maximum value may be 14*80*8*3=26,880.

According to an embodiment, the UE may identify an offset value that varies according to whether a two-step RACH procedure is configured. For example, in case that no two-step RACH procedure is configured for the UE, the offset value may be 14*80*8*2 and, in case that a two-step RACH procedure is configured for the UE, the offset value may be 14*80*8*3. The UE may identify whether a two-step RACH procedure through an SIB that transmits system information.

The above-described RA-RNTI may be an RNTI for receiving a PDCCH that schedules msg2 in a four-step RACH procedure. The disclosure may be expanded to an RNTI for receiving a PDCCH that schedules msgB in a two-step RACH procedure. More specifically, a two-step RACH procedure may be configured for the SBFD-capable UE. For example, the SBFD-capable UE may perform a two-step RACH procedure by using a second valid RACH occasion. The SBFD-capable UE may monitor a PDCCH scrambled by the msgB-RNTI in order to receive msgB. The msgB-RNTI may also be calculated as the same value in overlapped valid RACH occasions. Methods for solving this are disclosed.

According to an embodiment, as in Equation 5, the calculation equation of msgB-RNTI may be updated. In case that the SBFD-capable UE performs a two-step RACH procedure, the UE may calculate the updated msgB-RNTI by a new calculation equation. The SBFD-capable UE may receive a PDCCH that schedules msgB by using the msgB-RNTI.

$$msgB - RNTI = 1 + s\_id + 14 * t\_id + 14 * 80 * f\_id + 14 * 80 * 8 * ul\_carrier \_id + 14 * 80 * 8 * 2 + Offset\_msgB \qquad Equation 5$$

The definition of s_id, t_id, f_id, and ul_carrier_id may be the same as in Equation 2, and Offset msgB may be an offset value. According to an embodiment, the value of Offset msgB may be determined as follows:

According to an embodiment, Offset msgB may be determined to be 14*80*8. For example, the calculation equation of msgB-RNTI may be msgB-RNTI=1+s_id+14*1 id+14*80*f_id+14*80*8*ul_carrier_id+14*80*8*3. This may be used in case that RA-RNTI is not updated as in Equation 3.

According to an embodiment, the offset value of RA-RNTI may be Offset=14*80*8*3. In this case, the offset value of msgB-RNTI may be Offset_msgB=14*80*8*2. For example, the calculation equation of msgB-RNTI may be msgB-RNTI=1+s_id+14*t_id+14*80*f_id+14*80*8*ul_carrier_id+14*80*8*4.

Table 17 summarizes methods according to the disclosure.

TABLE 17

| | | |
|---|---|---|
| Conven- | RA-RNTI for 1st | 1 + s_id + 14*t_id + 14*80*f_id + |
| tional | type of valid ROs | 14*80*8*ul_carrier_id |
| | MsgB-RNTI for 1st | 1 + s_id + 14*t_id + 14*80*f_id + |
| | type of valid ROs | 14*80*8*ul_carrier_id + 14*80*8*2 |
| Proposal 1 | RA-RNTI for 2nd | 1 + s_id + 14*t_id + 14*80*f_id + |
| | type of valid ROs | 14*80*8*ul_carrier_id + 14*80*8*2 |
| | when 2-step RACH | |
| | is not configured | |
| | RA-RNTI for 2nd | 1 + s_id + 14*t_id + 14*80*f_id + |
| | type of valid ROs | 14*80*8*ul_carrier_id + 14*80*8*3 |
| | when 2-step RACH | |
| | is configured | |
| Proposal 2 | RA-RNTI for 2nd | 1 + s_id + 14*t_id + 14*80*f_id + |
| | type of valid ROs | 14*80*8*ul_carrier_id + 14*80*8*3 |
| | (regardless of 2step | |
| | RACH configuration) | |
| Proposal 3 | MsgB-RNTI for 2nd | 1 + s_id + 14*t_id + 14*80*f_id + |
| | type of valid ROs | 14*80*8*ul_carrier_id + 14*80*8*4 |

<Second Method: Changing Definition of f_id>

FIG. 13 illustrates examples of a valid RACH occasion in connection with a TDD configuration and an SBFD configuration according to various embodiments of the disclosure.

According to various embodiments of the disclosure, referring to FIG. 13, the UE may determine F RACH occasions (RO) in the frequency domain according to a PRACH configuration. The maximum value of F may be 8. For example, the UE may determine F RACH occasions at different locations in the frequency domain according to a PRACH configuration, and the index of ROs may be f_id=0, 1, . . . , F−1. According to an embodiment, the lowest RACH occasion in the frequency domain is f_id=0, and the value of f_id may increase in ascending order of frequency.

According to an embodiment, referring to FIG. 13, the UE may determine F 4 RACH occasions 1300, 1310, 1320, and 1330 according to a PRACH configuration. According to an embodiment, the lowest RACH occasion 1300 in the frequency domain may be f_id=0, the second lowest RACH occasion 1310 may be f_id=1, the third lowest RACH occasion 1320 may be f_id=2, and the fourth lowest RACH occasion 1330 may be f_id=3.

In the following description, the number F of ROs in the frequency domain according to the first PRACH configuration may be referred to as F1, and the number F of ROs in the frequency domain according to the second PRACH configuration may be referred to as F2. In addition, according to the first PRACH configuration, ROs may have f_id=0, 1, . . . , F1-1 and, according to the second PRACH configuration, ROs may have f_id=0, 1, . . . , F2-1.

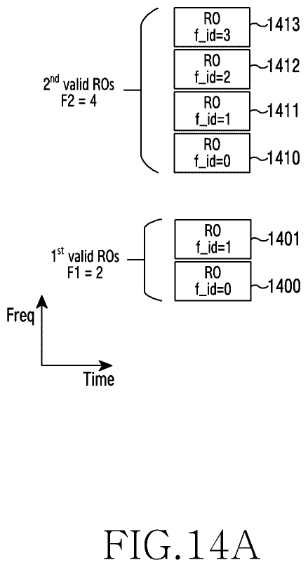

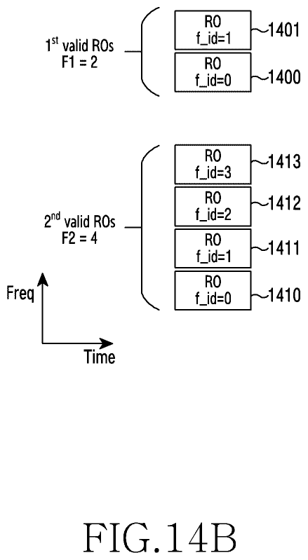

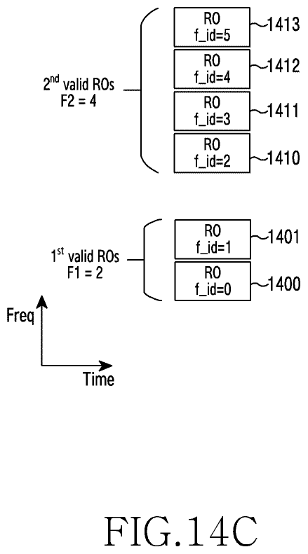

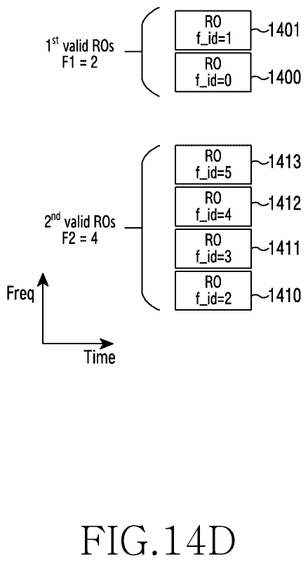

FIGS. 14A to 14D, 15A, 15B, 16A to 16D, and 17 illustrate various methods for f_id of valid RACH occasions according to various embodiments of the disclosure.

According to an embodiment, according to Equation 2, the UE may use the value of f_id when calculating the RA-RNTI value.

According to an embodiment, in the second method, the UE may use the frequency domain index f_id of overlapped valid RACH occasions differently from each other. More specifically, the above-described overlapping may occur in the time domain. Therefore, no overlapping may occur in the frequency domain. Referring to FIGS. 14A to 14D, the UE may determine F1=2 first valid RACH occasions in the frequency domain according to the first PRACH configuration. In addition, the UE may determine F2=4 second valid RACH occasions in the frequency domain according to the second PRACH configuration.

According to an embodiment, referring to FIGS. 14A and 14B, the UE may separately identify f_id with regard to each PRACH configuration. The index of F1=2 first valid RACH occasions 1400 and 1401 may be f_id=0 and f_id=1, respectively. The index of F2=4 second valid RACH occasions 1410, 1411, 1412, and 1413 may be f_id=0, f_id=1, f_id=2, and f_id=3, respectively. Therefore, first valid RACH occasions and second valid RACH occasions corresponding to f_id=0 and f_id=1 may correspond to the same RA-RNTI value.

In order to solve the above-mentioned problem, f_id may be identified simultaneously between overlapped valid RACH occasions. Referring to FIGS. 14C and 14D, the index of F1=2 first valid RACH occasions 1400 and 1401 may be f_id=0 and f_id=1, respectively. In addition, the index of F2=4 second valid RACH occasions 1410, 1411, 1412, and 1413 may be f_id=F1, f_id=F1+1, f_id=F1+2, and f_id=F1+3, respectively. For example, the frequency index of the first valid RACH occasions 1400 and 1401 may be indexed first, and the index of the second valid RACH occasions 1410, 1411, 1412, and 1413 may be indexed next. For reference, the reason the frequency index of the first valid RACH occasions is indexed first may be for the purpose of maintaining the same frequency index because valid RACHs may be used by a TDD UE.

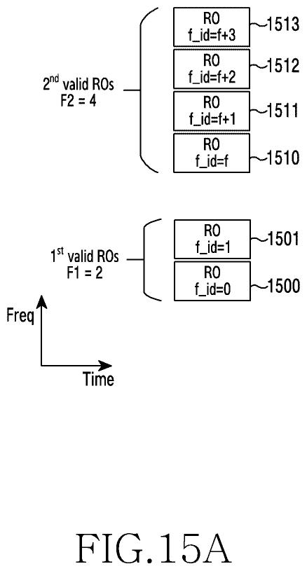

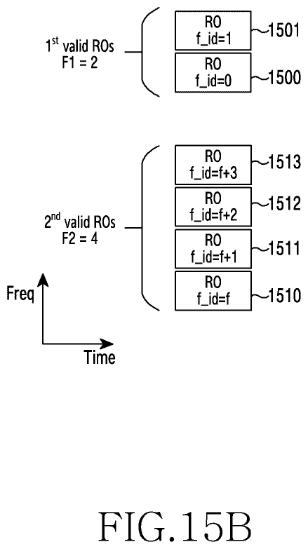

According to an embodiment, in another method, when the frequency index of second valid RACH occasions is indexed according to the second PRACH configuration, an offset value f may be introduced. Referring to FIGS. 15A and 15B, the UE may identify the frequency index of first valid RACH occasions according to the first PRACH configuration, starting from 0. The index of F1=2 first valid RACH occasions 1500 and 1501 may be f_id=0 and f_id=1, respectively. The UE may identify the frequency index of second valid RACH occasions according to the second PRACH configuration, starting from the offset value f. The index of F2=4 second valid RACH occasions 1510, 1511, 1512, and 1513 may be f_id=f, f_id=f+1, f_id=f+2, and f_id=f+3, respectively, wherein f is the offset value.

According to an embodiment, the offset value f may be configured according to the second PRACH configuration. Therefore, in case that the UE acquires second PRACH configuration information, the UE may acquire the offset value as well. If the second PRACH configuration information does not include the offset value f, the UE may assume f=0.

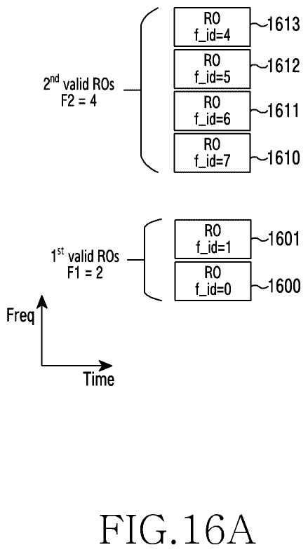

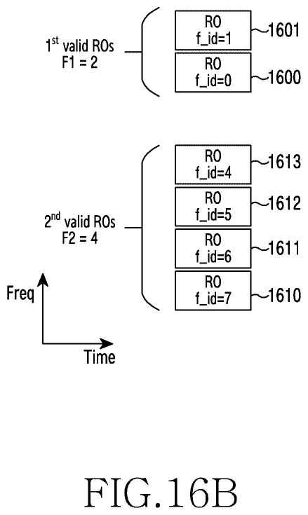

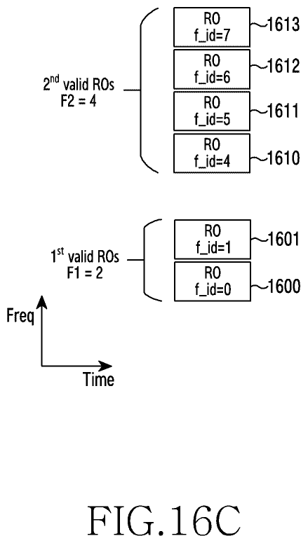

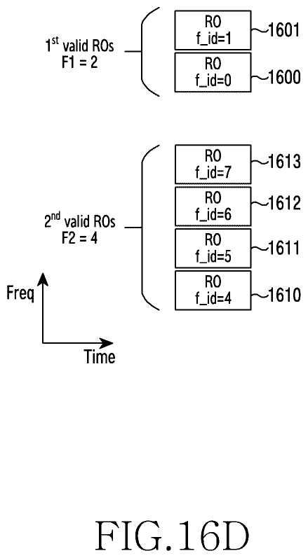

According to an embodiment, in another method, when the frequency index of second valid RACH occasions is indexed according to the second PRACH configuration, f_id may decrease by 1, starting from 7. Referring to FIGS. 16A and 16B, the UE may index the frequency index of first valid RACH occasions according to the first PRACH configuration, starting from 0. The index of F1=2 first valid RACH occasions 1600 and 1601 may be f_id=0 and f_id=1, respectively. The UE may decrease the frequency index of second valid RACH occasions according to the second PRACH configuration by 1, starting from 7. The index of F2=4 second valid RACH occasions 1610, 1611, 1612, and 1613 may be f_id=7, f_id=6, f_id=5, and f_id=4, respectively. In FIGS. 16A and 16B, a second valid RACH occasion having a low frequency may have a larger f_id than a second valid RACH occasion having a high frequency. This is because, although f_id is indexed in ascending order of frequency axis, f_id has decreased by 1, starting from 7. Referring to FIGS. 16C and 16D, when the frequency index of second valid RACH occasions is indexed according to the second PRACH configuration, f_id may be indexed in descending order of frequency axis, and f_id may decrease by 1, starting from 7. The index of F2=4 second valid RACH occasions 1610, 1611, 1612, and 1613 may be f_id=4, f_id=5, f_id=6, and f_id=7, respectively. The above-described method is characterized in that f_id of first valid RACH occasions is indexed in ascending order, starting from 0, and f_id of second valid RACH occasions is indexed in descending order, starting from 7.

<Third Method: Changing Definition of s_id>

According to various embodiments of the disclosure, when calculating RA-RNTI corresponding to a second valid RACH occasion, s_id may be applied differently. Referring to Equation 2, s_id may be the index of the first OFDM symbol of a RACH occasion. In case that a first valid RACH occasion and a second valid RACH occasion have the same starting symbol, the RA-RNTI value may be identical. For example, in case that different values of s_id are satisfied, the RA-RNTI value may be different. In the disclosure, various methods having different values of s_id are described.

According to an embodiment, in case that a first valid RACH occasion and a second valid RACH occasion are identical, the UE may change the s_id value of the second valid RACH occasion. For example, a value larger than existing s_id by a predetermined amount may be changed to new s_id. The predetermined amount may be 1. For example, the UE may change s_id+1, which is larger than existing s_id by 1, to the new s_id value. In general, the UE may change s_id+X, which is larger than existing s_id by X, to the new s_id value.

According to an embodiment, s_id may have a value corresponding to one of 0, 1 . . . , 13. Therefore, s_id+X may also have a value corresponding to one of 0, 1, . . . , 13. To this end, a modulo operation may be performed. More specifically, the UE may change (s_id+X) mod 14 to the new s_id value.

According to an embodiment, the X value may be configured for the UE by the gNB. When receiving second PRACH configuration information, the UE may have the X value additionally configured therefor.

According to an embodiment, in case that a first valid RACH occasion and a second valid RACH occasion are identical, the UE may change the s_id value of the second valid RACH occasion to a specific value. For example, the specific value may be equal to 13. For example, the UE may not expect that the first valid RACH occasion will be s_id=13, and may expect that the second valid RACH occasion will be s_id=13.

According to an embodiment, the specific value may be configured for the UE by the gNB. When receiving second PRACH configuration information, the UE may have the X value additionally configured therefor.

Although the disclosure is described with regard to a scheme in which the changed s_id value is used when calculating the RA-RNTI value of a second valid RACH occasion, this may not be limited to s_id. For example, the same idea may be applied to t_id, f_id, and ul_carrier_id in the RA-RNTI calculation equation of Equation 2.

### <Fourth Method: Reusing SUL Value>

According to various embodiments of the disclosure, a SUL carrier may be used to secure uplink coverage. An SBFD operation may be identically used to expand uplink coverage. Therefore, simultaneously using the SUL and SBFD operation may be inefficient in terms of frequency use and costs. Therefore, the SBFD-capable UE may exclude the SBFD operation.

According to an embodiment, in the RA-RNTI calculation equation of Equation 2, the value of RA-RNTI may differ according to whether a valid RACH occasion corresponds to a normal UL carrier (NUL carrier) or corresponds to a SUL carrier. More specifically, in the case of the NUL carrier, ul_carrier_id=0 may hold and, in the case of the SUL carrier, ul_carrier_id=1 may hold. In this regard, ul_carrier_id=1 may be reused for a second valid RACH occasion. For example, ul_carrier_id=0 may be used when calculating RA-RNTI corresponding to a first valid RACH occasion, and ul_carrier_id=1 may be used when calculating RA-RNTI corresponding to a second valid RACH occasion.

### <Fifth Method: Configuring a Search Space for a Second Valid RACH Occasion>

According to various embodiments of the disclosure, in the first to fourth methods described above, methods for differently determining a RA-RNTI value corresponding to a first valid RACH occasion and a RA-RNTI value corresponding to a second valid RACH occasion have been disclosed. As another method of the disclosure, various methods wherein the RA-RNTI value corresponding to a first valid RACH occasion and the RA-RNTI value corresponding to a second valid RACH occasion are identically maintained, and a PDCCH is distinguished through another method will be described.

According to various embodiments of the disclosure, the fifth method of the disclosure may include a scheme wherein the UE may monitor a PDCCH that schedules msg2 by using the RA-RNTI, and the time interval for monitoring the PDCCH (for example, PDCCH monitoring occasion) may differ according to a first valid RACH occasion and a second valid RACH occasion. More specifically, in case that the UE transmits a PRACH preamble through a first valid RACH occasion, the UE may monitor the PDCCH by using the RA-RNTI at a PDCCH monitoring occasion configured according to ra-SearchSpace. In case that the UE transmits a PRACH preamble through a second valid RACH occasion, the UE may monitor the PDCCH by using the RA-RNTI at a PDCCH monitoring occasion configured according to a new search space. The new search space may be a search space different from ra-SearchSpace. For example, a PDCCH monitoring occasion corresponding to a first valid RACH occasion and a PDCCH monitoring occasion corresponding to a second valid RACH occasion may differ from each other. Therefore, in case that the UE successfully receives a PDCCH scrambled by the RA-RNTI at a PDCCH monitoring occasion corresponding to a first valid RACH occasion, the msg2 scheduled by the PDCCH may be deemed to correspond to the first valid RACH occasion. In case that the UE successfully receives a PDCCH scrambled by the RA-RNTI at a PDCCH monitoring occasion corresponding to a second valid RACH occasion, the msg2 scheduled by the PDCCH may be deemed to correspond to the second valid RACH occasion.

<Sixth Method: Indicating in a PDCCH that Schedules Msg2>

According to various embodiments of the disclosure, in the sixth method of the disclosure, the UE may monitor the PDCCH by using the RA-RNTI, and a specific field in a DCI format received successfully may indicate whether msg2 scheduled by DCI corresponds to a first valid RACH occasion, corresponds to a second valid RACH occasion, or corresponds to both. The DCI format scrambled by the RA-RNTI may be DCI format 1_0. The DCI format may include one-bit information for indicating the corresponding valid RACH occasion. If the one-bit information is 0, msg2 scheduled by the DCI format may correspond to a first valid RACH occasion. If the one-bit information is 1, msg2 scheduled by the DCI format may correspond to a second valid RACH occasion. Obviously, this is not limitative, and the opposite case may be included.

According to an embodiment, the one-bit information may be indicated by using one bit among reserved bits of DCI format 1_0. More specifically, DCI format 1_0 scrambled by the RA-RNTI may have the following fields:
Frequency domain resource assignment
Time domain resource assignment
VRB-to-PRB mapping
Modulation and coding scheme
TB scaling
Least significant bits (LSBs) of system frame number (SFN)
Reserved bits

One bit among the reserved bits may be reused for the above-mentioned purpose.

<Seventh Method: Indicating in a RAR UL Grant that Schedules Msg3 PUSCH>

According to various embodiments of the disclosure, in the seventh method of the disclosure, the UE may monitor the PDCCH by using the RA-RNTI. In case that the UE succeeds in PDCCH reception, the UE may receive a PDSCH scheduled by the PDCCH. The PDSCH may include msg2 information. In addition, the PDSCH may include a RAR UL grant (for example, msg3 RAR UL grant) that schedules a msg3 PUSCH. The msg3 RAR UL grant includes scheduling information regarding a PUSCH including msg3.

According to an embodiment, the msg3 RAR UL grant may include the following pieces of information:
Frequency hopping flag—1 bit
PUSCH frequency resource allocation—14 bits
PUSCH time resource allocation—4 bits
MCS—4 bits
TPC command for PUSCH—3 bits
CSI request—1 bit

According to an embodiment, the UE may determine, from information of the msg3 RAR UL grant, whether msg2 corresponds to a first valid RACH occasion, corresponds to a second valid RACH occasion, or corresponds to both.

According to an embodiment, more specifically, one bit among the msg3 RAR UL grant may be used as an indicator indicating whether msg3 corresponds to a first valid RACH occasion, corresponds to a second valid RACH occasion, or corresponds to both. One-bit information may be determined as at least one of the following pieces of information:
One bit of frequency hopping flag: in this case, the UE may assume that frequency hopping is indicated always. As another example, the UE may assume that frequency hopping is not indicated always.
One bit of PUSCH frequency resource allocation: in this case, the UE may use one most significant bit (MSB) of PUSCH frequency resource allocation as an indicator. The MSB may exclude an indicator that indicates the hopping offset of PUSCH frequency resource allocation. The UE may identify PUSCH frequency resource allocation by using remaining bits other than the above-mentioned one bit. If necessary, the UE may interpret PUSCH frequency resource allocation by inserting “0” into the excluded one bit.
One bit of PUSCH time resource allocation: in this case, the UE may use MSB one bit of PUSCH time resource allocation as an indicator. The UE may identify PUSCH time resource allocation by using remaining three bits other than the above-mentioned one bit. Eight rows having a low index in a PUSCH time resource allocation table may be indicated. If necessary, the UE may produce four bits by inserting “0” into the excluded one bit, and may interpret PUSCH time resource allocation by using this.
One bit of MCS: in this case, the UE may use MSB one bit of MCS as an indicator. The UE may identify MCS by using remaining three bits other than the above-mentioned one bit. Eight rows having a low index in a MCS table may be indicated. Furthermore, the gNB may configure, for the UE, indices of eight rows in the MCS table which three-bit MCS may indicate. One of the eight rows may be indicated to the UE by the three-bit MCS.
One bit of TPC command for PUSCH: in this case, the UE may use one bit of the TPC command for PUSCH as an indicator. The UE may identify the TPC command for PUSCH by using two bits other than the above-mentioned one bit.
CIS request one bit: CIS request one bit may be reserved instead of being used. The UE may use the above-mentioned one bit as an indicator.

### Embodiment 3: Overlapped RACH Occasion Drop/Prioritization

According to various embodiments of the disclosure, the UE may prioritize some RACH occasions among overlapped RACH occasions. For example, the UE may use only RACH occasions that a prioritized among overlapped RACH occasions, and may not transmit/use RACH occasions having a low priority.

According to an embodiment, a high priority may be given to a first valid RACH occasion. This may be for the purpose of preventing a failure to use RACH occasions used by an existing TDD UE.

According to an embodiment, whether overlapping occurs may be determined as follows:

In the first method, in case that a first valid RACH occasion and a second valid RACH occasion are included in the same slot, the UE may use only the first valid RACH occasion and may not use the second valid RACH occasion.

In the second method, in case that a first valid RACH occasion and a second valid RACH occasion are included in the same symbol, the UE may use only the first valid RACH occasion and may not use the second valid RACH occasion. This may correspond to a situation in which the first valid RACH occasion and the second valid RACH occasion overlap in at least one symbol.

In the third method, in case that a first valid RACH occasion and a second valid RACH occasion start in the same symbol, the UE may use only the first valid RACH occasion and may not use the second valid RACH occasion. This may correspond to a situation in which the first valid RACH occasion and the second valid RACH occasion have the same starting timepoint.

In the fourth method, in case that a first valid RACH occasion and a second valid RACH occasion are included in the same slot or same symbol or same starting symbol, the UE may use only the first valid RACH occasion and may not use the second valid RACH occasion. In case that F1 first valid RACH occasions are included in the frequency domain (for example, f_id=0, 1, . . . , F1-1), and F2 second valid RACH occasions are included in the frequency domain (for example, f_id=0, 1, . . . , F2-1), the UE may not use F1 second valid RACH occasions having the same f_id as the first valid RACH occasion, among the second valid RACH occasions. In addition, the UE may not use (F2−F1) second valid RACH occasions, the f_id of which is not identical to that of the first valid RACH occasions, among the second valid RACH occasions. This may be applied to a case of F2>F1.

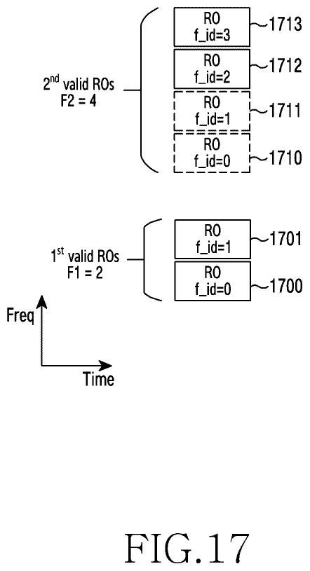

According to an embodiment, FIG. 17 illustrates RACH occasions according to the fourth method. Referring to FIG. 17, the UE may identify the frequency index of first valid RACH occasions according to the first PRACH configuration, starting from 0. The index of F1=2 first valid RACH occasions 1700 and 1701 may be f_id=0 and f_id=1, respectively. The UE may identify the frequency index of second valid RACH occasions according to the second PRACH configuration, starting from 0. The index of F2=4 second valid RACH occasions 1710, 1711, 1712, and 1713 may be f_id=0, f_id=1, f_id=2, and f_id=3, respectively. Two second valid RACH occasions 1710 and 1711 use the same f_id=0 and f_id=1 as the first valid RACH occasions 1700 and 1701, and the UE may thus not use the two second valid RACH occasions 1710 and 1711. However, two second valid RACH occasions 1712 and 1713 have a different f_id, and the UE may thus use the two second valid RACH occasions 1710 and 1711.

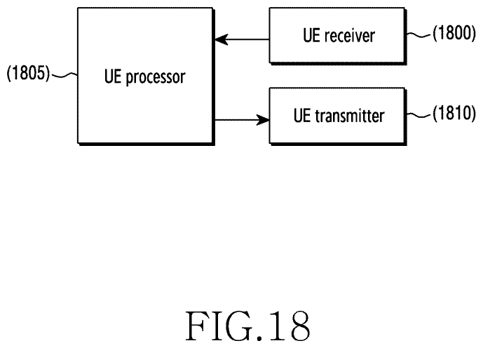

FIG. 18 illustrates a structure of a UE in a wireless communication system according to an embodiment of the disclosure.

Referring to FIG. 18, the UE may include a transceiver, which refers to a UE receiver 1800 and a UE transmitter 1810 as a whole, a memory (not illustrated), and a UE processor 1805 (or UE controller or processor). The UE transceiver 1800 and 1810, the memory, and the UE processor 1805 may operate according to the above-described communication methods of the UE. The UE processor 1805 may control operations of the UE according to not only the above-described respective embodiments but also combinations of at least one thereof. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include a storage medium such as a read only memory (ROM), a random access memory (RAM), a hard disk, a compact disc-ROM (CD-ROM), or a digital versatile disc (DVD), or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

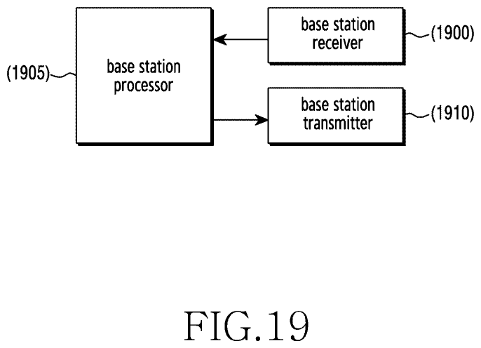

FIG. 19 illustrates a structure of a base station in a wireless communication system according to an embodiment of the disclosure.

Referring to FIG. 19, the base station may include a transceiver, which refers to a base station receiver 1900 and a base station transmitter 1910 as a whole, a memory (not illustrated), and a base station processor 1905 (or base station controller or processor). The base station transceiver 1900 and 1910, the memory, and the base station processor 1905 may operate according to the above-described communication methods of the base station. The base station processor 1905 may control operations of the base station according to not only the above-described respective embodiments but also combinations of at least one thereof. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include a storage medium such as a ROM, a RAM, a hard disk, a CD-ROM, or a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A user equipment (UE) in a wireless communication system, the UE comprising:
a transceiver; and
a controller coupled with the transceiver, and configured to:
receive, from a base station, first random access channel (RACH) configuration associated with time division duplex (TDD) configuration,
receive, from the base station, second RACH configuration associated with subband full duplex (SBFD) configuration,
identify a first RACH occasion based on the first RACH configuration,
identify a second RACH occasion based on the first RACH configuration and the second RACH configuration, and
transmit, to the base station, a preamble on the first RACH occasion or the second RACH occasion,
wherein the preamble is transmitted on the second RACH occasion in case that the second RACH occasion is valid.

2. The UE of claim 1, wherein the second RACH occasion is valid in case that:
the second RACH occasion is within SBFD symbols; or
the second RACH occasion starts from SBFD symbol and ends in non-SBFD symbol.

3. The UE of claim 1, wherein the second RACH occasion starts at least N symbols after a latest symbol for a synchronization signal block (SSB).

4. The UE of claim 1, wherein, in case that the second RACH occasion is overlapped with the first RACH occasion, the second RACH occasion is invalid.

5. A base station in a wireless communication system, the base station comprising:
a transceiver; and
a controller coupled with the transceiver, and configured to:
transmit, to a user equipment (UE), first random access channel (RACH) configuration associated with time division duplex (TDD) configuration,
transmit, to the UE, second RACH configuration associated with subband full duplex (SBFD) configuration, and
receive, from the UE, a preamble on a first RACH occasion based on the first RACH configuration or a second RACH occasion based on the first RACH configuration and the second RACH configuration,
wherein the preamble is received on the second RACH occasion in case that the second RACH occasion is valid.

6. The base station of claim 5, wherein the second RACH occasion is valid in case that:
the second RACH occasion is within SBFD symbols; or
the second RACH occasion starts from SBFD symbol and ends in non-SBFD symbol.

7. The base station of claim 5, wherein the second RACH occasion starts at least N symbols after a latest symbol for a synchronization signal block (SSB).

8. The base station of claim 5, wherein, in case that the second RACH occasion is overlapped with the first RACH occasion, the second RACH occasion is invalid.

9. A method performed by a user equipment (UE) in a wireless communication system, the method comprising:
receiving, from a base station, first random access channel (RACH) configuration associated with time division duplex (TDD) configuration;
receiving, from the base station, second RACH configuration associated with subband full duplex (SBFD) configuration;
identifying a first RACH occasion based on the first RACH configuration;
identifying a second RACH occasion based on the first RACH configuration and the second RACH configuration; and
transmitting, to the base station, a preamble on the first RACH occasion or the second RACH occasion,
wherein the preamble is transmitted on the second RACH occasion in case that the second RACH occasion is valid.

10. The method of claim 9, wherein the second RACH occasion is valid in case that:
the second RACH occasion is within SBFD symbols; or
the second RACH occasion starts from SBFD symbol and ends in non-SBFD symbol.

11. The method of claim 9, wherein the second RACH occasion starts at least N symbols after a latest symbol for a synchronization signal block (SSB).

12. The method of claim 9, wherein, in case that the second RACH occasion is overlapped with the first RACH occasion, the second RACH occasion is invalid.

13. A method performed by a base station in a wireless communication system, the method comprising:
transmitting, to a user equipment (UE), first random access channel (RACH) configuration associated with time division duplex (TDD) configuration;
transmitting, to the UE, second RACH configuration associated with subband full duplex (SBFD) configuration; and
receiving, from the UE, a preamble on a first RACH occasion based on the first RACH configuration or a second RACH occasion based on the first RACH configuration and the second RACH configuration,
wherein the preamble is received on the second RACH occasion in case that the second RACH occasion is valid.

14. The method of claim 13, wherein the second RACH occasion is valid in case that:
the second RACH occasion is within SBFD symbols; or
the second RACH occasion starts from SBFD symbol and ends in non-SBFD symbol.

15. The method of claim 13, wherein the second RACH occasion starts at least N symbols after a latest symbol for a synchronization signal block (SSB).

16. The method of claim 13, wherein, in case that the second RACH occasion is overlapped with the first RACH occasion, the second RACH occasion is invalid.
